(19) United States
(12) Patent Application Publication
(10) Pub. No.: US 2026/0057195 A1
(43) Pub. Date: Feb. 26, 2026

(54) COMPUTING TECHNOLOGIES FOR EVALUATING LINGUISTIC CONTENT TO PREDICT IMPACT ON USER ENGAGEMENT ANALYTIC PARAMETERS

(71) Applicant: Welocalize, Inc., New York, NY (US)

(72) Inventors: Olga Beregovaya, Imperial Beach, CA (US); Jon Cambra Guinea, New York, NY (US); David Clarke, New York, NY (US); Nileshkumar Rawal, Monrovia, MD (US); Boris Strepacki, Naperville, IL (US); Kevin Tong, North Babylon, NY (US); Alex Yanishevsky, Swampscott, MA (US)

(21) Appl. No.: 19/105,775

(22) PCT Filed: Aug. 17, 2023
(86) PCT No.: PCT/US2023/030442

§ 371 Date: Feb. 21, 2025

Related U.S. Application Data
(60) Provisional application No. 63/401,094, filed on Aug. 25, 2022.

(51) Int. Cl. G06F 40/58; G06F 40/166; G06F 40/263

(52) U.S. Cl. CPC G06F 40/58; G06F 40/166; G06F 40/263

(57) ABSTRACT

Correlations between a set of linguistic features identified in an unstructured text recited in a source language and a set of user engagement analytic parameters may be measured by a machine learning model selected based on a set of performance metrics from a set of machine learning models trained by a set of supervised machine learning algorithms on (i) a set of unstructured texts recited in the source language and containing the set of linguistic features and (ii) the set of user engagement analytic parameters measured for the set of unstructured texts. The machine learning model grades the unstructured text recited in the source language to determine whether the unstructured text recited in the source language should be (1) edited in the source language and then translated into the target language or (2) translated from the source language to the target language as is.

### CROSS-REFERENCE TO RELATED PATENT APPLICATION

This patent application claims a benefit of priority to U.S. Provisional Patent Application 63/401,094 filed 25 Aug. 2022; which is incorporated by reference herein for all purposes.

### TECHNICAL FIELD

This disclosure relates to computational linguistics.

### BACKGROUND

Currently, there are no known computing technologies to measure correlations between a set of linguistic features (e.g., a number of nouns, an adjective-noun density) identified in an unstructured text (e.g., a news article, a legal document) recited in a source language (e.g., English, Russian) and a set of user engagement analytic parameters (e.g., a time period spent on a web page, a conversion rate). As such, some language service providers (e.g., a translation vendor, a localization vendor) translate the unstructured text from the source language to a target language (e.g., Hebrew, Italian), while being agnostic as to what the set of user engagement analytic parameters would indicate. For example, if the set of user engagement analytic parameters would indicate a relatively poor user engagement with respect to the unstructured text recited in the source language, then translating the unstructured text from the source language to the target language is wasteful, because the relatively poor user engagement is likely to persist for the unstructured text recited in the target language as well.

Further, for some language service providers, there is currently no known recommendation engine (or other forms of executable logic) to drive workflow for various technology-driven decision-making pivot points at various stages of workflow dispatch, translation, and quality assurance within various modern service delivery and translation management platforms to expedite speed of translation workflow process and improve quality of final translation product, while also increasing computational efficiency and decreasing network latency. This may be so at least because content transformation decisions are made manually by a human actor. For example, some content type analysis may be performed by human evaluators using a manual process (e.g., based on spreadsheets), thereby driving workforce selection matched to content type decisions (e.g., by skillset, specialization, years of experience). Likewise, various workflow routing decisions may be following similar human content evaluation processes (e.g., use of machine translation, machine translation post-editing, full human translation, transcreation). Similarly, to determine a scope of a linguistic quality assurance (LQA) process, i.e., how much content is to be sampled within the LQA process, random content selection or oversampling is currently employed because there is currently no known algorithmic content selection methodology based on content linguistic features. Additionally, such form of random content selection or oversampling exists because there is currently no known approach of building and training machine learning models based on “gold standard” data for specific content types, which would allow to identify “outliers” that may potentially pose quality risk and should be subject of the LQA process, as opposed to random content sampling. Resultantly, this state of being does not allow any form of visual presentation informative of a performed linguistic feature analysis, a corresponding workflow recommendation, and a corresponding recommendation on the scope of the LQA process performed, especially with an ability to drill down into this visual presentation.

### SUMMARY

This disclosure solves various technological problems described above.

Initially, these technologies may measure correlations between the set of linguistic features identified in the unstructured text recited in the source language and the set of user engagement analytic parameters. These correlations may be measured by a machine learning model selected based on a set of performance metrics from a set of machine learning models trained by a set of supervised machine learning algorithms (e.g., a classification algorithm, a linear regression algorithm) on (i) a set of unstructured texts recited in the source language and containing the set of linguistic features and (ii) the set of user engagement analytic parameters measured for the set of unstructured texts to correlate how the set of linguistic features identified in the set of unstructured texts is predicted to impact the set of user engagement analytic parameters. Therefore, the machine learning model grades the unstructured text recited in the source language to determine whether the unstructured text recited in the source language should be (1) edited in the source language and then translated into the target language or (2) translated from the source language to the target language as is. Therefore, the unstructured text recited in the source language can be translated to the target language, without being agnostic as to what the set of user engagement analytic parameters would indicate.

Optionally, for some translations noted above, these technologies may enable various recommendation engines (or other forms of executable logic) to drive workflow for various technology-driven decision-making pivot points at various stages of workflow dispatch, translation, and quality assurance within various modern service delivery and translation management platforms to expedite speed of translation workflow process and improve quality of final translation product, while also increasing computational efficiency and decreasing network latency. This occurs by the recommendation engines (or other forms of executable logic) (1) profiling a source content (e.g., a descriptive text, an unstructured text) recited in a source language (e.g., Russian) based on various natural language processing (NLP) techniques, (2) routing the source content among translation workflow processes (e.g., machine translation with manual post-edits if necessary or manual translation) within the recommendation engines (or other forms of executable logic) to be translated from the source language to a target language (e.g., English) based on such source profiling and satisfaction or non-satisfaction of corresponding thresholds to form a target content (e.g., a descriptive text, an unstructured text) recited in the target language, (3) profiling the target content recited in the target language based on various NLP techniques, and (4) performing a targeted LQA process on the target content recited in the target language by corresponding routing of the target content among translation workflow processes within the recommendation engines (or other forms of executable logic) if warranted based on such target profiling and satisfaction or non-satisfaction of corresponding thresholds, as further explained below. Note that this process may be practiced independent and distinct of measuring correlations between the set of linguistic features identified in the unstructured text recited in the source language and the set of user engagement analytic parameters.

When used, this unconventional approach is technologically beneficial because various NLP techniques are used as an automated workflow decision-driving mechanism in accurately managing workflows of files (e.g., data files, text files, productivity files) on enterprise scale, including for the targeted LQA process, in contrast to a conventional approach of having various content transformation decisions being made manually by a human actor. Such technological benefits increase computational efficiency, decrease network latency, expedite speed of translations, and improve translation quality, while simultaneously being more cost-effective and less laborious than the conventional approach. For example, when content (e.g., a descriptive text, an unstructured text) is routed for machine translation even though such content is not suited for machine translation, there are significant additional post-editing manual translation efforts, which are time-consuming and laborious, while also being wasteful in computational cycles and network bandwidth. Therefore, the unconventional approach noted above minimizes or eliminates these significant additional post-editing manual translation efforts. Likewise, unlike random content selection or oversampling for the targeted LQA process, the unconventional approach noted above enables or maximizes targeted search for “real” poor quality candidates, which leads to significant reduction of time and labor for the targeted LQA process, while being efficient in computational cycles and network bandwidth. Additionally, this unconventional approach enables a form of visual presentation informative of performed linguistic feature analysis, a corresponding workflow recommendation, and a corresponding recommendation on the scope of the LQA process performed, especially with the ability to drill down into this visual presentation.

In an embodiment, there is a system comprising: a computing instance including an editor profile accessed from an editor terminal, a translator profile accessed from a translator terminal, and a logic including a binary file containing a machine learning model selected based on a set of performance metrics from a set of machine learning models trained by a set of supervised machine learning algorithms on (i) a set of unstructured texts recited in a source language and containing a set of linguistic features and (ii) a set of user engagement analytic parameters measured for the set of unstructured texts to correlate how the set of linguistic features identified in the set of unstructured texts is predicted to impact the set of user engagement analytic parameters, wherein the editor profile includes an editor language setting, wherein the translator profile includes a first translator language setting and a second translator language setting, wherein the computing instance is programmed to: receive (i) an unstructured text recited in the source language and containing the set of linguistic features and (ii) an identifier of a target language from a data source external to the computing instance, wherein the unstructured text is not present in the set of unstructured texts; input the unstructured text into the logic such that the logic reads the binary file and generates a grade for the unstructured text via the machine learning model, wherein the grade correlates how the set of linguistic features identified in the unstructured text is predicted to impact the set of user engagement analytic parameters for the unstructured text; determine whether the grade satisfies a decision threshold associated with how the set of linguistic features identified in the unstructured text is predicted to impact the set of user engagement analytic parameters; route the unstructured text within the computing instance based on the grade not satisfying the decision threshold such that the unstructured text is (i) assigned to the editor profile based on the editor language setting corresponding to the source language detected in the unstructured text and (ii) edited via the editor profile from the editor terminal to satisfy the decision threshold based on a corrective content (i) generated by the logic when the logic generated the grade for the unstructured text via the machine learning model and (ii) presented to the editor profile to be visualized at the editor terminal such that the unstructured text as edited via the editor profile from the editor terminal based on the corrective content is again input into the logic for the logic to read the binary file, generate the grade for the unstructured text as edited via the editor profile from the editor terminal based on the corrective content via the machine learning model, and satisfy the decision threshold; and route the unstructured text within the computing instance based on the grade satisfying the decision threshold such that the unstructured text is (i) assigned to the translator profile based on the first translator language setting corresponding to the source language detected in the unstructured text and the second translator language setting corresponding to the identifier, (ii) translated via the translator profile from the translator terminal into the target language via the computing instance, and (iii) sent to the data source to be end-used.

In an embodiment, there is a system comprising: a computing instance programmed to: access a source descriptive text recited in a source language; within a predetermined workflow containing a first sub-workflow, a second sub-workflow, a third sub-workflow, and a fourth sub-workflow: form a source workflow decision for the source descriptive text to profile the source descriptive text based on: identifying the source language in the source descriptive text; tokenizing the source descriptive text into a set of source tokens according to the source language that has been identified; tagging each source token selected from the set of source tokens with a part of source speech label according to the source language that has been identified such that a set of part of source speech labels is formed; segmenting each source token selected from the set of source tokens into a set of source syllables according to the source language that has been identified; determining whether the source descriptive text satisfies a source descriptive text threshold for the source language that has been identified, wherein the source descriptive text satisfies the source descriptive text threshold based on a source syntactic feature or a source semantic feature involving (i) the set of source tokens tagged according to the set of part of source speech labels or (ii) the set of source syllables; labeling the source descriptive text with a source pass label based on the source descriptive text threshold being satisfied or a source fail label based on the source descriptive text threshold not being satisfied, wherein the source workflow decision is formed based on the source descriptive text being labeled with the source pass label or the source fail label; route the source descriptive text to the first sub-workflow responsive to the source workflow decision being formed based on the source descriptive text being labeled with the source pass label or the second sub-workflow responsive to the source workflow decision being formed based on the source descriptive text being labeled with the source fail label; form a target workflow decision for the source descriptive text that was translated from the source language that has been identified into a target descriptive text recited in a target language during the first sub-workflow or the second sub-workflow to profile the target descriptive text based on: identifying the target language in the target descriptive text; tokenizing the target descriptive text into a set of target tokens according to the target language that has been identified; tagging each target token selected from the set of target tokens with a part of target speech label according to the target language that has been identified such that a set of part of target speech labels is formed; segmenting each target token selected from the set of target tokens into a set of target syllables according to the target language that has been identified; determining whether the target descriptive text satisfies a target descriptive text threshold for the target language that has been identified, wherein the target descriptive text satisfies the target descriptive text threshold based on a target syntactic feature or a target semantic feature involving (i) the set of target tokens tagged according to the set of part of target speech labels or (ii) the set of target syllables; labeling the target descriptive text with a target pass label based on the target descriptive text threshold being satisfied or a target fail label based on the target descriptive text threshold not being satisfied, wherein the target workflow decision is formed based on the target descriptive text being labeled with the target pass label or the target fail label; and route the target descriptive text to the third sub-workflow responsive to the target workflow decision being formed based on the target descriptive text being labeled with the target pass label or the fourth sub-workflow responsive to the target workflow decision being formed based on the target descriptive text being labeled with the target fail label.

### DESCRIPTION OF DRAWINGS

FIG. 1 shows a schematic diagram of an embodiment of a computing architecture for a system to perform linguistic content evaluations to predict performances in linguistic translation workflow processes based on natural language processing or to evaluate linguistic content to predict impact on a set of user engagement analytic parameters to route an unstructured text between an editing user interface and a translation user interface according to this disclosure.

FIG. 2 shows a schematic diagram of an embodiment of an application program from FIG. 1 to perform linguistic content evaluations to predict performances in linguistic translation workflow processes based on natural language processing according to this disclosure.

FIG. 3 shows a flowchart of an embodiment of a process to operate the application program of FIG. 2 to perform linguistic content evaluations to predict performances in linguistic translation workflow processes based on natural language processing according to this disclosure.

FIG. 4 shows an embodiment of a dashboard with a summary of linguistic feature analysis, workflow recommendation and recommendation on a scope of LQA according to this disclosure.

FIG. 5 shows an embodiment of a screen for drill-down data of the dashboard of FIG. 4 according to this disclosure.

FIG. 6 shows an embodiment of a screen for pass/fail data according to this disclosure.

FIG. 7 shows a schematic diagram of an embodiment of an application program from FIG. 1 to evaluate linguistic content to predict impact on a set of user engagement analytic parameters to route an unstructured text between an editing user interface and a translation user interface according to this disclosure.

FIG. 8 shows a flowchart of an embodiment of a process to operate the application program of FIG. 7 to evaluate linguistic content to predict impact on a set of user engagement analytic parameters to route an unstructured text between an editing user interface and a translation user interface according to this disclosure.

FIG. 9 shows a diagram of an embodiment of correlations between some linguistic features and some user engagement analytic parameters and a corrective content generated based thereon according to this disclosure.

FIG. 10 shows a first flowchart of an embodiment of a process to train a model and a second flowchart of an embodiment of a process to deploy the model as trained according to this disclosure.

FIG. 11 shows a diagram of an embodiment of count, mean, standard deviation, min, and max for numeric variables used in the process to train the model of FIG. 10 according to this disclosure.

FIG. 12 shows a diagram of an embodiment of a scatterplot between features A and B used in the process to train the model of FIG. 10 according to this disclosure.

FIG. 13 shows a diagram of an embodiment of a histogram of correlations between X and frequency used in the process to train the model of FIG. 10 according to this disclosure.

FIG. 14 shows a diagram of an embodiment of a visualization of sentence embeddings reduced to two dimensions to ascertain semantic similarity and dissimilarity used in the process to train the model of FIG. 10 according to this disclosure.

FIG. 15 shows a diagram of an embodiment of a visualization of features and target variables where each visualized bubble has an area/circumference to visually indicate a mutual information score (larger is higher) and each visualized line has a thickness to visually indicate correlations (thicker is higher) used in the process to train the model of FIG. 10 according to this disclosure.

FIG. 16 shows a diagram of an embodiment of a listing of a set of algorithmic identifiers used in the process to train the model of FIG. 10 according to this disclosure.

FIG. 17 shows a diagram of an embodiment of a table listing a set of performance metrics to select a trained machine learning model to evaluate linguistic content to predict impact on a set of user engagement analytic parameters to route an unstructured text between an editing user interface and a translation user interface according to this disclosure.

FIG. 18 shows a screenshot of an embodiment of a dashboard with a color-coded pie-diagram and a set of color-coded file groupings generated based on the trained machine learning model selected in FIG. 17 according to this disclosure.

### DETAILED DESCRIPTION

As explained above, this disclosure solves various technological problems described above.

Initially, these technologies may measure correlations between the set of linguistic features identified in the unstructured text recited in the source language and the set of user engagement analytic parameters. These correlations may be measured by the machine learning model selected based on the set of performance metrics from the set of machine learning models trained by the set of supervised machine learning algorithms (e.g., a classification algorithm, a linear regression algorithm) on (i) the set of unstructured texts recited in the source language and containing the set of linguistic features and (ii) the set of user engagement analytic parameters measured for the set of unstructured texts to correlate how the set of linguistic features identified in the set of unstructured texts is predicted to impact the set of user engagement analytic parameters. Therefore, the machine learning model grades the unstructured text recited in the source language to determine whether the unstructured text recited in the source language should be (1) edited in the source language and then translated into the target language or (2) translated from the source language to the target language as is. Therefore, the unstructured text recited in the source language can be translated to the target language, without being agnostic as to what the set of user engagement analytic parameters would indicate.

Optionally, for some translations noted above, these technologies may enable various recommendation engines (or other forms of executable logic) to drive workflow for various technology-driven decision-making pivot points at various stages of workflow dispatch, translation, and quality assurance within various modern service delivery and translation management platforms to expedite speed of translation workflow process and improve quality of final translation product, while also increasing computational efficiency and decreasing network latency. This occurs by the recommendation engines (or other forms of executable logic) (1) profiling a source content (e.g., a descriptive text, an unstructured text) recited in a source language (e.g., Russian) based on various natural language processing (NLP) techniques, (2) routing the source content among translation workflow processes (e.g., machine translation with manual post-edits if necessary or manual translation) within the recommendation engines (or other forms of executable logic) to be translated from the source language to a target language (e.g., English) based on such source profiling and satisfaction or non-satisfaction of corresponding thresholds to form a target content (e.g., a descriptive text, an unstructured text) recited in the target language, (3) profiling the target content recited in the target language based on various NLP techniques, and (4) performing a targeted LQA process on the target content recited in the target language by corresponding routing of the target content among translation workflow processes within the recommendation engines (or other forms of executable logic) if warranted based on such target profiling and satisfaction or non-satisfaction of corresponding thresholds, as further explained below. Note that this process may be practiced independent and distinct of measuring correlations between the set of linguistic features identified in the unstructured text recited in the source language and the set of user engagement analytic parameters.

When used, this unconventional approach is technologically beneficial because various NLP techniques are used as an automated workflow decision-driving mechanism in accurately managing workflows of files (e.g., data files, text files, productivity files) on enterprise scale, including for the targeted LQA process, in contrast to a conventional approach of having various content transformation decisions being made manually by a human actor. Such technological benefits increase computational efficiency, decrease network latency, expedite speed of translations, and improve translation quality, while simultaneously being more cost-effective and less laborious than the conventional approach. For example, when content (e.g., a descriptive text, an unstructured text) is routed for machine translation even though such content is not suited for machine translation, there are significant additional post-editing manual translation efforts, which are time-consuming and laborious, while also being wasteful in computational cycles and network bandwidth. Therefore, the unconventional approach noted above minimizes or eliminates these significant additional post-editing manual translation efforts. Likewise, unlike random content selection or oversampling for the targeted LQA process, the unconventional approach noted above enables or maximizes targeted search for “real” poor quality candidates, which leads to significant reduction of time and labor for the targeted LQA process, while being efficient in computational cycles and network bandwidth. Additionally, this unconventional approach enables a form of visual presentation informative of performed linguistic feature analysis, a corresponding workflow recommendation, and a corresponding recommendation on the scope of the LQA process performed, especially with the ability to drill down into this visual presentation.

This disclosure is now described more fully with reference to all attached figures, in which some embodiments of this disclosure are shown. This disclosure may, however, be embodied in many different forms and should not be construed as necessarily being limited to various embodiments disclosed herein. Rather, these embodiments are provided so that this disclosure is thorough and complete, and fully conveys various concepts of this disclosure to skilled artisans. Note that like numbers or similar numbering schemes can refer to like or similar elements throughout.

Various terminology used herein can imply direct or indirect, full or partial, temporary or permanent, action or inaction. For example, when an element is referred to as being “on,” “connected” or “coupled” to another element, then the element can be directly on, connected or coupled to the other element or intervening elements can be present, including indirect or direct variants. In contrast, when an element is referred to as being “directly connected” or “directly coupled” to another element, there are no intervening elements present.

As used herein, a term “or” is intended to mean an inclusive “or” rather than an exclusive “or.” That is, unless specified otherwise, or clear from context, “X employs A or B” is intended to mean any of natural inclusive permutations. That is, if X employs A; X employs B; or X employs both A and B, then “X employs A or B” is satisfied under any of the foregoing instances. For example, X includes A or B can mean X can include A, X can include B, and X can include A and B, unless specified otherwise or clear from context.

As used herein, each of singular terms “a,” “an,” and “the” is intended to include a plural form (e.g., two, three, four, five, six, seven, eight, nine, ten, tens, hundreds, thousands, millions) as well, including intermediate whole or decimal forms (e.g., 0.0, 0.00, 0.000), unless context clearly indicates otherwise. Likewise, each of singular terms “a,” “an,” and “the” shall mean “one or more,” even though a phrase “one or more” may also be used herein.

As used herein, each of terms “comprises,” “includes,” or “comprising,” “including” specify a presence of stated features, integers, steps, operations, elements, or components, but do not preclude a presence or addition of one or more other features, integers, steps, operations, elements, components, or groups thereof.

As used herein, when this disclosure states herein that something is “based on” something else, then such statement refers to a basis which may be based on one or more other things as well. In other words, unless expressly indicated otherwise, as used herein “based on” inclusively means “based at least in part on” or “based at least partially on.”

As used herein, terms, such as “then,” “next,” or other similar forms are not intended to limit an order of steps. Rather, these terms are simply used to guide a reader through this disclosure. Although process flow diagrams may describe some operations as a sequential process, many of those operations can be performed in parallel or concurrently. In addition, the order of operations may be re-arranged.

As used herein, a term “response” or “responsive” are intended to include a machine-sourced action or inaction, such as an input (e.g., local, remote), or a user-sourced action or inaction, such as an input (e.g., via user input device).

As used herein, a term “about” or “substantially” refers to a +/−10% variation from a nominal value/term.

Although various terms, such as first, second, third, and so forth can be used herein to describe various elements, components, regions, layers, or sections, note that these elements, components, regions, layers, or sections should not necessarily be limited by such terms. Rather, these terms are used to distinguish one element, component, region, layer, or section from another element, component, region, layer, or section. As such, a first element, component, region, layer, or section discussed below could be termed a second element, component, region, layer, or section, without departing from this disclosure.

Unless otherwise defined, all terms (including technical and scientific terms) used herein have a same meaning as commonly understood by skilled artisans to which this disclosure belongs. These terms, such as those defined in commonly used dictionaries, should be interpreted as having a meaning that is consistent with their meaning in context of relevant art and should not be interpreted in an idealized or overly formal sense, unless expressly so defined herein.

Features or functionality described with respect to certain embodiments may be combined and sub-combined in or with various other embodiments. Also, different aspects, components, or elements of embodiments, as disclosed herein, may be combined and sub-combined in a similar manner as well. Further, some embodiments, whether individually or collectively, may be components of a larger system, wherein other procedures may take precedence over or otherwise modify their application. Additionally, a number of steps may be required before, after, or concurrently with embodiments, as disclosed herein. Note that any or all methods or processes, as disclosed herein, can be at least partially performed via at least one entity or actor in any manner.

Hereby, all issued patents, published patent applications, and non-patent publications that are mentioned or referred to in this disclosure are herein incorporated by reference in their entirety for all purposes, to a same extent as if each individual issued patent, published patent application, or non-patent publication were specifically and individually indicated to be incorporated by reference. To be even more clear, all incorporations by reference specifically include those incorporated publications as if those specific publications are copied and pasted herein, as if originally included in this disclosure for all purposes of this disclosure. Therefore, any reference to something being disclosed herein includes all subject matter incorporated by reference, as explained above. However, if any disclosures are incorporated herein by reference and such disclosures conflict in part or in whole with this disclosure, then to an extent of the conflict or broader disclosure or broader definition of terms, this disclosure controls. If such disclosures conflict in part or in whole with one another, then to an extent of conflict, the later-dated disclosure controls.

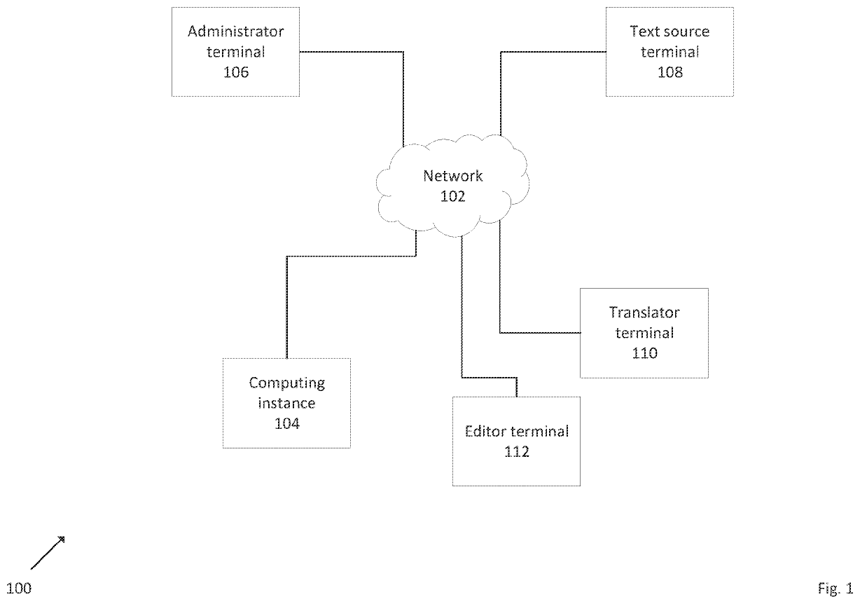

FIG. 1 shows a schematic diagram of an embodiment of a computing architecture for a system to perform linguistic content evaluations to predict performances in linguistic translation workflow processes based on natural language processing or to evaluate linguistic content to predict impact on a set of user engagement analytic parameters to route an unstructured text between an editing user interface and a translation user interface according to this disclosure. In particular, a computing architecture 100 includes a network 102, a computing instance 104, an administrator terminal 106, a text source terminal 108, a translator terminal 110, and an editor terminal 112.

The network 102 is a wide area network (WAN), a local area network (LAN), a cellular network, a satellite network, or any other suitable network, which can include Internet. Although the network 102 is illustrated as a single network 102, this is not required and the network 102 can be a group or collection of suitable networks collectively operating together in concert to accomplish various functionality as disclosed herein. For example, the group or collection of WANs may form the network 102 to operate as disclosed herein.

The computing instance 104 is a server (e.g., hardware, virtual, application, database) running an operating system (OS) and an application program thereon. The application program is accessible via an administrator user profile, a text source user profile, a translator user profile, and an editor user profile, each of which may be stored in the computing instance with its own set of internal settings, whether these user profiles are stored internal or external to the application program, and having its own corresponding user interfaces (e.g., a graphical user interface) to perform its corresponding tasks disclosed herein. These user profiles may be granted access to the application program via corresponding user logins (e.g., user name/passwords, biometrics). Although the computing instance 104 is illustrated as a single computing instance 104, this is not required and the computing instance 104 can be a group or collection of suitable servers collectively operating together in concert to accomplish various functionality as disclosed herein. For example, the group or collection of servers may collectively host the application program (e.g., via a distributed on-demand resilient cloud computing instance to enable a cloud-native infrastructure) to operate as disclosed herein.

The administrator terminal 106 is a workstation running an OS and a web browser thereon. The web browser of the administrator terminal 106 interfaces with the application program of the computing instance 104 over the network 102 such that the administrator user profile is operative through the web browser of the administrative terminal 106 for various administrative tasks disclosed herein. The administrator terminal 106 may be a desktop computer, a laptop computer, or other suitable computers. As such, the administrator terminal 106 administers the computing instance 104 via the administrator user profile through the web browser of the administrative terminal 106 over the network 102. For example, the administrator terminal 106 is enabled to administer the computing instance 104 via the administrator user profile through the web browser of the administrative terminal 106 over the network 102 to manage user profiles, user interfaces, workflow dispatches, text translations, LQA processes, file routing, security settings, unstructured texts, user engagement analytic parameters, machine learning models, machine learning, and other suitable administrative functions.

Although the administrator terminal 106 is illustrated as a single administrator terminal 106, this is not required and the administrator terminal 106 can be a group or collection of administrator terminals 106 operating independent of each other to perform administration of the computing instance 104 over the network 102, which may be in parallel or not in parallel, to accomplish various functionality as disclosed herein. For example, there may be a group or collection of administrator terminals 106 administering the computing instance 104 in parallel via a group or collection of administrator user profiles through the web browsers of the administrative terminals 106 over the network 102 to operate as disclosed herein. Likewise, note that although the administrator terminal 106 is shown as being separate and distinct from the text source terminal 108 and the translator terminal 110 and the editor terminal 112, this is not required and the administrator terminal 106 can be common or one with at least one of the text source terminal 108 (e.g., for testing purposes) or the translator terminal 110 (e.g., for testing purposes) or the editor terminal 112 (e.g., for testing purposes).

The text source terminal 108 is a workstation running an OS and a web browser thereon. The web browser of the text source terminal 108 interfaces with the application program of the computing instance 104 over the network 102 such that the text source user profile is operative through the web browser of the text source terminal 108 for various descriptive (or unstructured) text tasks disclosed herein. The text source terminal 108 may be a desktop computer, a laptop computer, or other suitable computers. As such, the text source terminal 108 is enabled to input (e.g., upload, select, identify, paste, reference) a source descriptive (or unstructured) text (e.g., an article, an essay, an electronic conversation, a legal document, a patent specification, a contract) recited in a source language (e.g., Spanish) or a copy thereof via the text source user profile through the web browser of the text source terminal 108 over the network 102 to the application program of the computing instance 104 for determining correlation with the set of user engagement analytic parameters based on the machine learning model, as disclosed herein, or subsequent translation of the source descriptive (or unstructured) text by the application program of the computing instance 104 from the source language to the target language (e.g., French). The text source terminal 108 is also enabled to receive the source descriptive (or unstructured) text translated into the target language from the application program of the computing instance 104 via the text source user profile through the web browser of the text source terminal 108 over the network 102. Such receipt may be displayed on the text source terminal 108 via the text source user profile through the web browser of the text source terminal 108 or sent (e.g., by email) to the text source terminal 108, whether as a file containing the source descriptive (or unstructured) text translated into the target language from the application program of the computing instance 104 or a link to access (e.g., download) the file containing source descriptive (or unstructured) text translated into the target language from the application program of the computing instance 104 via the text source user profile through the web browser of the text source terminal 108.

Although the text source terminal 108 is illustrated as a single text source terminal 108, this is not required and the text source terminal 108 can be a group or collection of text source terminals 108 operating independent of each other to input, which may be in parallel or not in parallel, various descriptive (or unstructured) texts recited in source languages (e.g., Italian, German) into the application program of the computing instance 104 over the network 102 for the application program of the computing instance 104 to determine correlation with the set of user engagement analytic parameters based on the machine learning model, as disclosed herein, or to translate, whether in parallel or not in parallel, or enable translation of those descriptive (or unstructured) texts into target languages (e.g., Portuguese, Polish). Likewise, the group or collection of text source terminals 108 may be enabled to receive the source descriptive (or unstructured) texts translated into the target languages from the application program of the computing instance 104 via a group or collection of text source user profiles through the web browsers of the text source terminals 108 over the network 102. For example, there may be a group or collection of text source terminals 108 inputting in parallel the descriptive (or unstructured) texts recited in the source languages into the application program of the computing instance 104 via a group or collection of text source user profiles through the web browsers of the text source terminals 108 over the network 102 to determine correlation with the set of user engagement analytic parameters based on the machine learning model, as disclosed herein, or to translate or enable translation of the descriptive (or unstructured) texts from the source languages to the target languages. Then, the application program of the computing instance 104 may be outputting in parallel or not in parallel the descriptive (or unstructured) texts translated into the target languages to the group or collection of text source user profiles through the web browsers of the text source terminals 108 over the network 102. Likewise, note that although the text source terminal 108 is shown as being separate and distinct from the administrator terminal 106 and the translator terminal 110 and the editing terminal 112, this is not required and the text source terminal 108 can be common or one with at least one of the administrator terminal 106 (e.g., for testing purposes) or the translator terminal 110 (e.g., for testing purposes) or the editing terminal 112 (e.g., for testing purposes).

The translator terminal 110 is a workstation running an OS and a web browser thereon. The web browser of the translator terminal 110 interfaces with the application program of the computing instance 104 over the network 102 such that the translator user profile is operative through the web browser of the translator terminal 110 for various translation tasks disclosed herein. The translator terminal 110 may be a desktop computer, a laptop computer, or other suitable computers. As such, the translator terminal 110 is enabled to access the application program of the computing instance 104 via the translator user profile through the web browser of the translator terminal 110 over the network 102 and then input or edit the source descriptive (or unstructured) text in the target language in the application program of the computing instance 104 over the network 102 if necessary for the targeted LQA disclosed herein, after the source descriptive (or unstructured) text has been input into the application program of the computing instance 104 via the text source terminal 108, as disclosed herein, and processed to determine correlation with the set of user engagement analytic parameters based on the machine learning model, as disclosed herein. The application program of the computing instance 104 saves such inputs or edits from the translator user profile through the web browser of the translator terminal 110 to the source descriptive (or unstructured) text in the target language to subsequently avail the source descriptive (or unstructured) text in the target language to the text source terminal 108, as input or edited via the translator user profile through the web browser of the translator terminal 110.

Although the translator terminal 110 is illustrated as a single translator terminal 110, this is not required and the translator terminal 110 can be a group or collection of translator terminals 110 operating independent of each other to input or edit via a group of translator user profiles through the web browsers of the translator terminals 110 over the network 102, which may be in parallel or not in parallel, various descriptive (or unstructured) texts recited in target languages (e.g., Latvian, Greek) in the application program of the computing instance 104 post-translations thereof for saving in the application program of the computing instance 104 and subsequent availing of such descriptive (or unstructured) texts, as input or edited via the group of translator user profiles through the web browsers of the translator terminals 110 over the network 102, by the application program of the computing instance 104 to the text source terminal 108 over the network 102. Likewise, note that although the translator terminal 110 is shown as being separate and distinct from the administrator terminal 106 and the text source terminal 108 and the editing terminal 112, this is not required and the translator terminal 110 can be common or one with at least one of the administrator terminal 106 (e.g., for testing purposes) or the text source terminal 108 (e.g., for testing purposes) or the editing terminal 112 (e.g., for testing purposes).

The editor terminal 112 is a workstation running an OS and a web browser thereon. The web browser of the editor terminal 112 interfaces with the application program of the computing instance 104 over the network 102 such that the editor user profile is operative through the web browser of the translator terminal 110 for various editing tasks disclosed herein. The editor terminal 112 may be a desktop computer, a laptop computer, or other suitable computers. As such, the editor terminal 112 is enabled to access the application program of the computing instance 104 via the editor user profile through the web browser of the editor terminal 112 over the network 102 and then edit the source descriptive (or unstructured) text in the source language in the application program of the computing instance 104 over the network 102, if determined to be needing editing based on the machine learning model grading the source descriptive (or unstructured) text in the source language for correlation with the set of user engagement analytic parameters, as disclosed herein, after the source descriptive (or unstructured) text has been input into the application program of the computing instance 104 via the text source terminal 108, as disclosed herein. The application program of the computing instance 104 saves such inputs or edits from the editor user profile through the web browser of the editor terminal 112 to the source descriptive (or unstructured) text in the source language to subsequently have the source descriptive (or unstructured) text in the source language graded by the machine learning model for correlation with the set of user engagement analytic parameters, as disclosed herein. Note that the application program of the computing instance 104 may employ a file versioning technology to account for and track each version of the source descriptive (or unstructured) text edited via the editor user profile through the web browser of the editor terminal 112.

Although the editor terminal 112 is illustrated as a single editor terminal 112, this is not required and the editor terminal 112 can be a group or collection of editor terminals 112 operating independent of each other to input or edit via a group of editor user profiles through the web browsers of the editor terminals 112 over the network 102, which may be in parallel or not in parallel, various descriptive (or unstructured) texts recited in source languages (e.g., Latvian, Greek) in the application program of the computing instance 104 pre-translations thereof, if determined to be needing editing based on the machine learning model grading the various source descriptive (or unstructured) texts in the source languages for correlation with the set of user engagement analytic parameters, as disclosed herein, and then saving in the application program of the computing instance 104 and subsequent availing of such descriptive (or unstructured) texts, as input or edited via the group of editor user profiles through the web browsers of the editor terminals 112 over the network 102, by the application program of the computing instance 104 to the translator terminal 110 over the network 102. Likewise, note that although the editor terminal 112 is shown as being separate and distinct from the administrator terminal 106 and the text source terminal 108 and the translator terminal 110, this is not required and the editor terminal 112 can be common or one with at least one of the administrator terminal 106 (e.g., for testing purposes) or the text source terminal 108 (e.g., for testing purposes) or the translator terminal 112 (e.g., for testing purposes).

In one mode of operation, as further explained below, the administrative terminal 106, via the administrative user profile, can browse to administer the application program of the computing instance 104 over the network 102 to enable the text source terminal 108 to input (e.g., upload) a source content (e.g., a descriptive text, an unstructured text, an article, an essay, an electronic conversation, a legal document, a patent specification, a contract) recited in the source language (e.g., Turkish) via the text source user profile into the application program of the computing instance 104 over the network 102. Optionally, the application program of the computing instance 104 may determine that the source content recited in the source language does not to be edited or further edited (e.g., iterative determination) for correlation or better or more correlation with the set of user engagement analytic parameters based on the machine learning model, as disclosed herein, then the application program of the computing instance 104 (1) profiles the source content recited in the source language based on various NLP techniques, (2) routes the source content among translation workflows (e.g., machine translation or manual edits) to be translated from the source language to the target language (e.g., English) based on such profiling and satisfaction or non-satisfaction of corresponding thresholds to form a target content (e.g., a descriptive text, an unstructured text) recited in the target language, (3) profiles the target content recited in the target language based on various NLP techniques, and (4) performs a targeted LQA process on the target content recited in the target language by corresponding routing of the target content among translation workflows if warranted based on such profiling and satisfaction or non-satisfaction of corresponding thresholds, as further explained below. For example, profiling the source descriptive text recited in the source language or the target language may sequentially include (1) tokenizing text to segment sentences, (2) perform part of speech tagging on tokenized text, (3) applying a Sonority Sequencing Principle (SSP) to tagged tokenized text to split words into syllables, (4) determining whether such syllabized text passes or fails on a per segment level using thresholds, weights, and predictive machine learning (ML) models, and (5) determining whether files sourcing the source descriptive text recited in the source language or the target language pass or fail using thresholds, weights, and predictive ML models. This unconventional approach is technologically beneficial because various NLP techniques are used as an automated workflow decision-driving mechanism in accurately managing workflows of files (e.g., data files, text files, productivity files) on enterprise scale, including for the targeted LQA process, in contrast to a conventional approach of having various content transformation decisions being made manually by a human actor. Such technological benefits increase computational efficiency, decrease network latency, expedite speed of translations, and improve translation quality, while simultaneously being more cost-effective and less laborious than the conventional approach. For example, when content (e.g., a descriptive text, an unstructured text) is routed for machine translation even though such content is not suited for machine translation, there are significant additional post-editing manual translation efforts, which are time-consuming and laborious, while also being wasteful in computational cycles and network bandwidth. Therefore, the unconventional approach noted above minimizes or eliminates these significant additional post-editing manual translation efforts. Likewise, unlike random content selection or oversampling for the targeted LQA process, the unconventional approach noted above enables or maximizes targeted search for “real” poor quality candidates, which leads to significant reduction of time and labor for the targeted LQA process, while being efficient in computational cycles and network bandwidth. However, if the application program of the computing instance 104 determines that the source content recited in the source language needs to be edited or further edited (e.g., iterative determination) for correlation or better or more correlation with the set of user engagement analytic parameters based on the machine learning model, as disclosed herein, then the application program of the computing instance 104 routes the source content recited in the source language to the editor user profile accessible via the editor terminal 112 to edit or further edit (e.g., iterative determination) the source content recited in the source language, as disclosed herein.

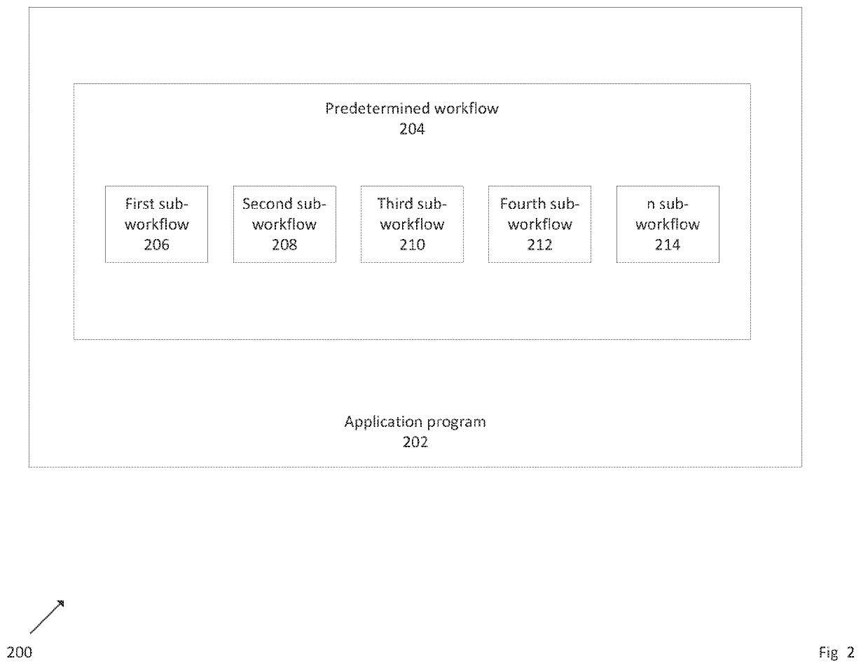

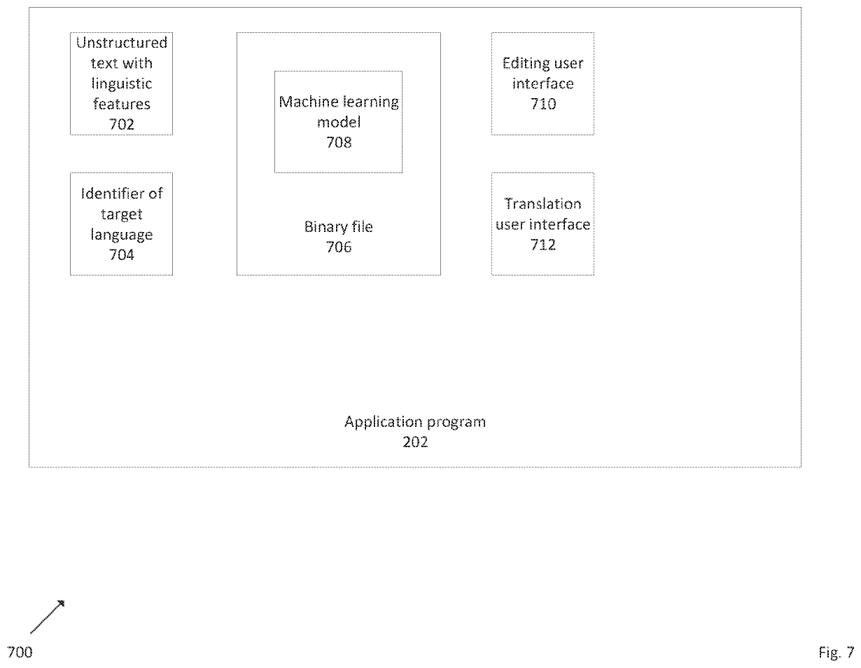

FIG. 2 shows a schematic diagram of an embodiment of an application program from FIG. 1 to linguistic content evaluations to predict performances in linguistic translation workflow processes based on natural language processing according to this disclosure. In particular, an architecture 200 includes an application program 202 (e.g., a logic, an executable logic) containing a predetermined workflow 204 (e.g., a task workflow) containing a first sub-workflow 206 (e.g., a task workflow), a second sub-workflow 208 (e.g., a task workflow), a third sub-workflow 210 (e.g., a task workflow), a fourth sub-workflow 212 (e.g., a task workflow), and an n sub-workflow 214 (e.g., a task workflow), some, most, many, or all may be invoked, trigged, or interfaced with via a respective application programming interface (API). The computing instance 104 hosts the architecture 200 and the application program of the computing instance 104 is the application program 202. Note that the architecture 200 may include other logical components, which may include what is shown and described in context of FIGS. 7-18 to enable those or other technologies, whether within predetermined workflow 204, the first sub-workflow 206, the second sub-workflow 208, the third sub-workflow 210, the fourth sub-workflow 212, the n sub-workflow 214, its own workflow, or be distributed among these or other workflows or external among these or other workflows or non-workflows as well.

The application program 202 may be implemented as or include a recommendation engine (e.g., a task-dedicated executable logic that can be started, stopped, or paused), a prediction engine (e.g., a task-dedicated executable logic that can be started, stopped, or paused), or another form of logic or executable logic including an enterprise content management (ECM) or task-allocation application program having a service-oriented architecture with a process driven messaging service in an event-driven process chain or a workflow or business-rules engine (e.g., a task-dedicated executable logic that can be started, stopped, or paused) to manage (e.g., start, stop, pause, handle, monitor, transition, allocate) the predetermined workflow 204 containing the first sub-workflow 206, the second sub-workflow 208, the third sub-workflow 210, the fourth sub-workflow 212, and the n sub-workflow 214 or other logical components, which may include what is shown and described in context of FIGS. 7-18 to enable those or other technologies or the first sub-workflow 206, the second sub-workflow 208, the third sub-workflow 210, the fourth sub-workflow 212, and the n sub-workflow 214 or other logical components, which may include what is shown and described in context of FIGS. 7-18 to enable those or other technologies, which may be via software-based workflow agents (e.g., a task-dedicated executable logic that acts for a user or other program in a relationship of agency) driving workflow or non-workflow steps. For example, the application program 202 may be a workflow application to automate, to at least some degree, an editing workflow process or processes or a translation workflow process or processes via a series of computing steps, although some steps may still require some human intervention, such as an approval or custom translation input or edits. Such automation may occur via a workflow management system (WfMS) that enables a logical infrastructure for set-up, performance, and monitoring of a defined sequence of tasks to translate or enable editing or translation. The workflow application may include a routing system (routing flow of information or document), a distribution system (transmits information to designated work positions or logical stations), a coordination system (manage conflicts or priority), and an agent system (task logic). Note that workflow may be separate or orchestrated to be separate from execution of the application program 202. For example, the application program 202 may be cloud-based to unify content, task, and talent management functions to transform content (e.g., a descriptive text, an unstructured text) securely and efficiently by integrating a content management system (CMS), a customer relationship management (CRM) system, a marketing automation platform (MAP), a product information management (PIM) software, and a translation management system (TMS). This configuration may enable pre-configured and adaptive workflows that manage content variability and ensure consistent performance across distributed project teams (e.g., managed via the translator user profiles). This enables control of workflows to manage risks while adapting to—and balancing—human work (e.g., managed via the editor user profiles or the translator user profiles) and process automation, to maximize efficiency without sacrificing quality. For example, the application program 202 may have a client portal to be accessed via the text source user profile operating the web browser of the text source terminal 108 over the network 102 to provide a private, secure gateway for visual review of translation quotes, start projects, view status, and get user questions answered.

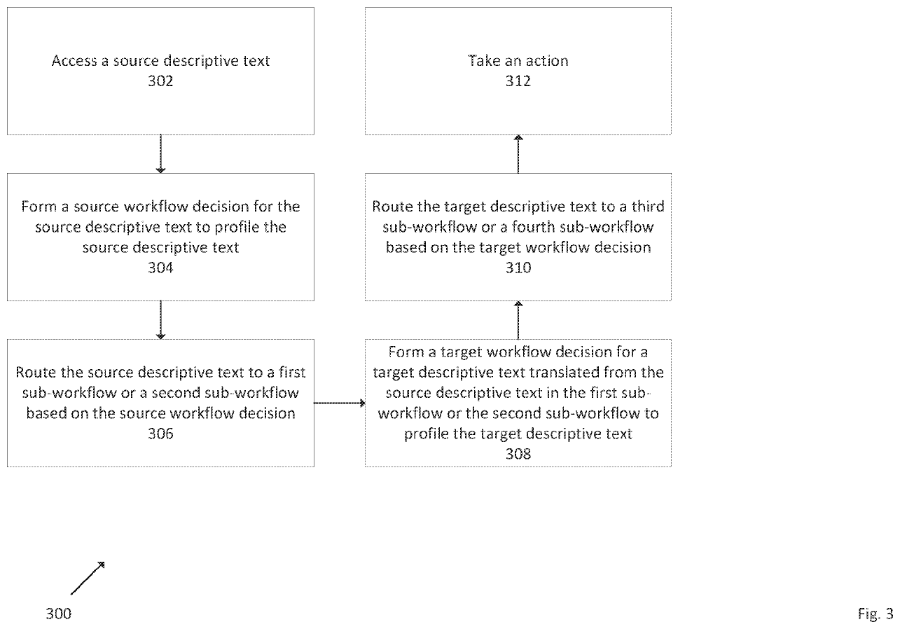

FIG. 3 shows a flowchart of an embodiment of a process to operate the application program of FIG. 2 to linguistic content evaluations to predict performances in linguistic translation workflow processes based on natural language processing according to this disclosure. In particular, a process 300 includes steps 302-312, which are performed via the computing architecture 100 and the architecture 200, as disclosed herein.

In step 302, the application program 202 accesses a source descriptive text (e.g., an article, an essay, an electronic conversation, a legal document, a patent specification, a contract) recited in a source language (e.g., Russian). This may occur by the text source terminal 108 inputting (e.g., uploading, selecting, identifying, pasting, referencing) the source descriptive text into the application program 202. The source descriptive text may include unstructured text. The application program 202 has the predetermined workflow 202 containing the first sub-workflow 206, the second sub-workflow 208, the third sub-workflow 210, the fourth sub-workflow 212, and the n sub-workflow 214. The application program 202 may (1) contain an NLP framework or model (e.g., an NLP engine from Stanford Stanza, spaCy, NLTK or custom engines) or interface with the NLP framework or model if the NLP is external to the application program 202 or (2) contain a suit of appropriate libraries (e.g., Python, regular expressions) or interface with the suitable suite of libraries if the suit of appropriate libraries is external to the application program 202.

In step 304, within the predetermined workflow 202 containing the first sub-workflow 206, the second sub-workflow 208, the third sub-workflow 210, the fourth sub-workflow 212, and the n sub-workflow 214, the application program 202 forms a source workflow decision for the source descriptive text to profile the source descriptive text based on various actions performed by the application program 202, which may invoke an API do these actions. When these actions are performed sequentially by the application program 202 as indicated below, then more precise profiling of the source descriptive text may occur.

These actions include (1) identifying the source language (e.g., Dutch, Hebrew) in the source descriptive text when the source language is not known or identified in advance or needs to be validated or confirmed even if known or identified in advance, although this action may be omitted when the source language is known or identified in advance or does not need to be validated or confirmed even if known or unknown or identified or not identified in advance. This action may be performed via running the source descriptive text against a trained NLP model for language identification, which can recognize many languages. For example, the trained NLP model may be a FastText model. If the source language is or is suspected to include at least two source languages (e.g., Arabic and Spanish) or a confirmation thereof is needed, then whatever source language that is dominant within the source descriptive text may be identified as the source language by (a) parsing the source descriptive text (or a portion thereof) into a preset number of lines (e.g., first 1000 consecutive lines contained within a fixed number of lines within a data structure or a file, or presented within a fixed display area), (b) identifying the source languages in the preset number of lines, and (c) identifying the source language from the source languages that is dominant in the preset number of lines based on a majority or minority analysis. For example. (a) the source descriptive text may be parsed into the preset number of lines (e.g., 750 consecutive lines contained within a fixed number of lines within a data structure or a file, or presented within a fixed display area), (b) Russian source language and English source language may be identified as being present in the preset number of lines, and (c) a majority or minority count is performed on the preset number of lines to determine whether Russian source language is a majority (or super-majority or greater) or minority (or super-minority or lesser) source language in the preset number of lines relative to English source language in the preset number of lines or whether English source language is a majority or minority source language in the preset number of lines relative to Russian source language in the preset number of lines. As such, if 95% (or another majority or super-majority or greater) of text within the preset number of lines recites Russian characters and 5% (or another minority or super-minority or lesser) of text within the preset number of lines recites English characters, then the source language that is dominant within the descriptive text will be identified as Russian (e.g., RU). This identifier may be subsequently used to configure, reconfigure, set, reset, activate, or reactivate other NLP or translation techniques disclosed herein.

These actions include (2) tokenizing the source descriptive text into a set of source tokens according to the source language that has been identified. For example, such tokenizing may include separating a piece of text into smaller units called tokens-words, characters, or sub-words. This action may be performed via inputting the source descriptive text into an NLP framework or model for the source language that has been identified. For example, such tokenization may be done by an NLP engine (e.g., Stanford Stanza, spaCy, NLTK). Note that if the source language is identified, but there is no ML model for the source language (e.g., a rare language), then the process 300 may stop here and the source descriptive text will not be processed further. For example, the application program 202 may contain or access a log to log an event that such locale is not supported or the application program 202 may generate a warning message. Otherwise, the process 300 proceeds further if the application program 202 contains or has access to an ML model for the source language that is identified.

The actions include (3) tagging each source token selected from the set of source tokens with a part of source speech label according to the source language that has been identified such that a set of part of source speech labels is formed. For example, such tagging may include assigning a part of speech to each given token by labelling each word in a sentence with its appropriate part of speech (e.g., nouns, verb, adverbs, adjectives, pronouns, conjunction and their sub-categories), although the token may also have one part of speech in that particular context (e.g., “file” may be a noun or verb but not both for that token). For example, such tagging may be done via a suite of libraries and programs based on grammatical rules and/or statistics or deep learning neural models (e.g., Stanford Stanza, NLTK library).

These actions include (4) segmenting each source token selected from the set of source tokens into a set of source syllables according to the source language that has been identified. For example, such segmenting may be in accordance with a SSP technique, which may aim to outline a structure of a syllable in terms of sonority. This form of segmentation enables a more accurate counting of syllables. For example, syllables may be counted based on a syllabic nucleus, typically a vowel, which denotes a sonority peak (sonority falls before and after the syllabic nucleus in a typical syllable). Therefore, more accurate counting of syllables is important for readability formulas (e.g., Flesch-Kincaid, Gunning-Fog, SMOG, RIX, LIX), which may be highly weighted features to determine pass/fail complexity of individual sentences for thresholds on a per segment basis (for the source descriptive text recited in the source language) and a per file (sourcing the source descriptive text recited in the source language) basis, as disclosed herein. Segmenting each source token selected from the set of source tokens into the set of source syllables according to the source language that has been identified may be performed by a programming package (e.g., from Python Package Index, Perl package, a group of regular expressions). If there is more than one language recited in the source descriptive text, then the programming package may be informed or configured of such state of being or there may be another programming package for another language.

The actions include determining whether the source descriptive text satisfies a source descriptive text threshold for the source language that has been identified. For example, there may be one source descriptive text threshold for one language (e.g., English) and another source descriptive text threshold for another language (e.g., Serbian). The application program 202 can perform such determination in various ways. One of such ways involves the application program 202 obtaining, receiving, reading, or otherwise accessing a set of historical data (e.g., a descriptive text, an unstructured text, configuration data, statistical data) for a particular domain, product, or subject matter (e.g., marketing documentation, technical documentation, legal documentation, contractual documentation, training documentation, product documentation) sourced from the administrator terminal 106 or the text source terminal 108. Then, the application program 202 performs, runs, receives, reads, or otherwise accesses an analysis on the set of historical data using a set of default thresholds, which may be set by the administrator terminal 106 or the translator terminal 110. The set of default thresholds has initially been formed, set, formatted, and input into the application program 202 from the administrator terminal 106 or the translator terminal 110 for each part of speech, readability, and complexity feature for each source language for which the application program 202 is programmed and each target language for which the application program 202 is programmed, based on interviews conducted with professional linguists operating the administrator terminal 106 or the translator terminal 110. Then, the application program 202 calibrates the set of default thresholds using data science and statistics techniques to form a set of calibrated thresholds. Such data science and statistics techniques may include an identification of one or two standard deviations from a mean formed, sourced or based on the analysis or the set of default thresholds to represent an outlier beyond an interquartile range (IQR) as per various calculations. These calculations may include (1) calculating the interquartile range for a set of data formed, sourced or based on the analysis or the set of default thresholds, (2) multiplying the IQR by 1.5 (an example constant used to discern outliers), (3) adding 1.5×IQR to a third quartile, where any number greater than this result is a suspected outlier; and (4) subtract 1.5×IQR from a first quartile, where any number less than this result is a suspected outlier After the application program 202 calibrates the set of default thresholds to form the set of calibrated thresholds for each feature, the application program 202 processes a set of documents (e.g., source descriptive text) related to that particular domain, product, or subject matter using the set of calibrated thresholds. If, in a particular sentence, that particular feature is greater than a calibrated threshold from the set of calibrated thresholds, then the application program 202 flags, deems, labels, semaphores, or otherwise associates that feature to be a FAIL (e.g., lower than threshold denotes FAIL for reading ease although vice versa is possible). The application program 202 counts a weight of each such failed feature towards an overall fail of a segment (or document) since feature weights are different. Ultimately, the application program 202 aggregates each feature FAIL for a sentence up to a file level to determine whether an entire file is cumulatively as a whole is a fail (and is recommended to be rewritten or edited), review via the translator terminal 110, or pass for subsequent process, as disclosed herein.

The source descriptive text threshold may be satisfied based on a syllabized text recited in the source language (from the set of source syllables) passing the source descriptive text threshold on a per segment level using predetermined thresholds, weights, and predictive ML models; or otherwise failing. Note that syllabization is one of many linguistic features that may be additionally or alternatively used, where some, most, or all of which may or may not be common with linguistic features disclosed in context of FIGS. 7-18. There may be thresholds for each part of speech. For example, a threshold may be satisfied (pass) based on syllabization, but not satisfied (fail) on number of nouns, although satisfaction or non-satisfaction may be vice versa. Some examples of such features include adjectives, nouns, proper nouns, word count, long words, numbers, punctuations, or other suitable features. The source descriptive text threshold may be satisfied based on a file sourcing the source descriptive text recited in the source language and the syllabized text recited in the source language (from the set of source syllables) passing the source descriptive text threshold on a per file basis (or as a whole) using predetermined thresholds, weights, and predictive ML models; or otherwise failing. The source descriptive text may satisfy the source descriptive text threshold based on a source syntactic feature within the syllabized text recited in the source language (from the set of source syllables) or a source semantic feature within the syllabized text recited in the source language (from the set of source syllables) involving (i) the set of source tokens tagged according to the set of part of source speech labels or (ii) the set of source syllables.

The source syntactic feature or the source semantic feature may involve a part of speech rule for the source language. The source syntactic feature or the source semantic feature may involve a complexity formula for the source language. For example, the complexity formula can be generic to source languages or one source language may have one complexity formula and another source language may have another complexity formula. The source syntactic feature or the source semantic feature may involve a readability formula (e.g., Flesch-Kincaid, Gunning-Fog. SMOG, LIX, RIX) for the source language. For example, the readability formula can be generic to source languages or one source language may have one readability formula and another source language may have another readability formula. The source syntactic feature or the source semantic feature may involve a measure of similarity to a historical source descriptive text for the source language (e.g., a baseline source descriptive text). The source syntactic feature or the source semantic feature may involve the set of source syllables satisfying or not satisfying a source syllable threshold for the source language. Note that syllabization is one of many linguistic features. There may be thresholds for each part of speech. For example, a threshold may be satisfied (pass) based on syllabization, but not satisfied (fail) on number of nouns, although satisfaction or non-satisfaction may be vice versa. Some examples of such features include adjectives, nouns, proper nouns, word count, long words, numbers, punctuations, or other suitable features.

The actions include labeling (e.g., flagging, associating, referencing, pointing, semaphoring) the source descriptive text with a source pass label based on the source descriptive text threshold being satisfied or a source fail label based on the source descriptive text threshold not being satisfied. Therefore, the source workflow decision profiling the source descriptive text recited in the source language is formed based on the source descriptive text being labeled with the source pass label or the source fail label.

In step 306, the application program 202 routes the source descriptive text to the first sub-workflow responsive to the source workflow decision being formed based on the source descriptive text being labeled with the source pass label or the second sub-workflow responsive to the source workflow decision being formed based on the source descriptive text being labeled with the source fail label. This enables a potential risk mitigation in case of a potential translation quality fail.

The first sub-workflow includes a machine translation. For example, the machine translation may include a machine translation API programmed to be invoked on routing to receive the source descriptive text recited in the source language, translate the source descriptive text recited in the source language from the source language into the target language (e.g., target descriptive text), and output the source descriptive text in the target language (e.g., target descriptive text) for subsequent use (e.g., saving, presentation, copying, sending). The application program 202 may contain the machine translation API or access the machine translation API if the machine translation API is external to the application program 202.

The second sub-workflow includes a user input that translates the source descriptive text from the source language to the target language, thereby forming the target descriptive text using a machine translation or a user input translation. For example, the application program 202 may present an interface to a user (e.g., a translator) to present the source descriptive text in the source language and enable the source descriptive text to be translated from the source language to the target language via the user entering the user input (e.g., a keyboard text entry or edits) to form the target descriptive text.

In step 308, within the predetermined workflow 202 containing the first sub-workflow 206, the second sub-workflow 208, the third sub-workflow 210, the fourth sub-workflow 212, and the n sub-workflow 214, the application program 202 forms a target workflow decision for the source descriptive text that was translated from the source language that has been identified into the target descriptive text recited in the target language during the first sub-workflow or the second sub-workflow to profile the target descriptive text based on various actions performed by the application program 202, which may invoke an API do these actions, which may be the API from the step 304. When these actions are performed sequentially by the application program 202 as indicated below, then more precise profiling of the source descriptive text may occur.

These actions include (1) identifying the target language in the target descriptive text. This action may be performed via running the target descriptive text against a trained NLP model for a language identification, which can recognize many languages. For example, the trained NLP model may be a FastText model.

The actions include (2) tokenizing the target descriptive text into a set of target tokens according to the target language that has been identified. For example, such tokenizing may include separating a piece of text into smaller units called tokens-, words, characters, or sub-words. This action may be performed via inputting the target descriptive text into an NLP framework or model for the target language that has be identified. For example, such tokenization may be done by an NLP engine (e.g., Stanford Stanza, spaCy, NLTK).

The actions include (3) tagging each target token selected from the set of target tokens with a part of target speech label according to the target language that has been identified such that a set of part of target speech labels is formed. For example, such tagging may include as the process of assigning one of several parts of speech to a given token by labelling each word in a sentence with its appropriate part of speech (e.g., nouns, verb, adverbs, adjectives, pronouns, conjunction and their sub-categories). For example, such tagging may be done via a suite of libraries and programs based on grammatical rules and/or statistics or deep learning neural models for NLP (e.g., NLTK library).

The actions include (4) segmenting each target token selected from the set of target tokens into a set of target syllables according to the target language that has been identified. For example, such segmenting may be in accordance with a SSP technique, which may aim to outline a structure of a syllable in terms of sonority. This form of segmentation enables a more accurate counting of syllables. For example, syllables may be counted based on a syllabic nucleus, typically a vowel, which denotes a sonority peak (sonority falls before and after the syllabic nucleus in a typical syllable). Therefore, more accurate counting of syllables is important for readability formulas (e.g., Flesch-Kincaid, Gunning-Fog, SMOG, LIX, RIX), which may be highly weighted features to determine pass/fail complexity of individual sentences for thresholds on a per segment basis (for the target descriptive text recited in the target language) and a per file (sourcing the target descriptive text recited in the target language) basis, as disclosed herein. Segmenting each target token selected from the set of target tokens into the set of target syllables according to the target language that has been identified may be performed by a programming package (e.g., from Python Package Index, Perl package, a group of regular expressions).

The actions include determining whether the target descriptive text satisfies a target descriptive text threshold for the target language that has been identified. For example, there may be one target descriptive text threshold for one language (e.g., English) and another target descriptive text threshold for another language (e.g., Serbian).

The application program 202 can perform such determination in various ways. One of such ways involves the application program 202 obtaining, receiving, reading, or otherwise accessing a set of historical data (e.g., a descriptive text, an unstructured text, configuration data, statistical data) for a particular domain, product, or subject matter (e.g., marketing documentation, technical documentation, legal documentation, contractual documentation, training documentation, product documentation) sourced from the administrator terminal 106 or the text source terminal 108. Then, the application program 202 performs, runs, receives, reads, or otherwise accesses an analysis on the set of historical data using a set of default thresholds, which may be set by the administrator terminal 106 or the translator terminal 110. The set of default thresholds has initially been formed, set, formatted, and input into the application program 202 from the administrator terminal 106 or the translator terminal 110 for each part of speech, readability, and complexity feature for each source language for which the application program 202 is programmed and each target language for which the application program 202 is programmed, based on interviews conducted with professional linguists operating the administrator terminal 106 or the translator terminal 110. Then, the application program 202 calibrates the set of default thresholds using data science and statistics techniques to form a set of calibrated thresholds. Such data science and statistics techniques may include an identification of one or two standard deviations from a mean formed, sourced or based on the analysis or the set of default thresholds to represent an outlier beyond an IQR as per various calculations. These calculations may include (1) calculating the interquartile range for a set of data formed, sourced or based on the analysis or the set of default thresholds. (2) multiplying the IQR by 1.5 (an example constant used to discern outliers), (3) adding 1.5×IQR to a third quartile, where any number greater than this result is a suspected outlier; and (4) subtract 1.5×IQR from a first quartile, where any number less than this result is a suspected outlier. After the application program 202 calibrates the set of default thresholds to form the set of calibrated thresholds for each feature, the application program 202 processes a set of documents (e.g., target descriptive text) related to that particular domain, product, or subject matter using the set of calibrated thresholds. If, in a particular sentence, that particular feature is greater than a calibrated threshold from the set of calibrated thresholds, then the application program 202 flags, deems, labels, semaphores, or otherwise associates that feature to be a FAIL (e.g., lower than threshold denotes FAIL for reading ease although vice versa is possible). The application program 202 counts a weight of each such failed feature towards an overall fail of a segment (or document) since feature weights are different. Ultimately, the application program 202 aggregates each feature FAIL for a sentence up to a file level to determine whether an entire file is cumulatively as a whole is a fail (and is recommended to be retranslated), review via the translator terminal 110, or pass for subsequent process, as disclosed herein.

The target descriptive text threshold may be satisfied based on a syllabized text recited in the target language (from the set of target syllables) passing the target descriptive text threshold on a per segment level using predetermined thresholds, weights, and predictive ML models; or otherwise failing. Note that syllabization is one of many linguistic features that may be additionally or alternatively used, where some, most, or all of which may or may not be common with linguistic features disclosed in context of FIGS. 7-18. There may be thresholds for each part of speech. For example, a threshold may be satisfied (pass) based on syllabization, but not satisfied (fail) on number of nouns, although satisfaction or non-satisfaction may be vice versa. Some examples of such features include adjectives, nouns, proper nouns, word count, long words, numbers, punctuations, or other suitable features. The target descriptive text threshold may be satisfied based on a file sourcing the target descriptive text recited in the target language and the syllabized text recited in the target language (from the set of target syllables) passing the source descriptive text threshold on a per file basis (or as a whole) using predetermined thresholds, weights, and predictive ML models; or otherwise failing. The target descriptive text may satisfy the target descriptive text threshold based on a target syntactic feature within the syllabized text recited in the target language (from the set of target syllables) or a target semantic feature within the syllabized text recited in the target language (from the set of target syllables) involving (i) the set of target tokens tagged according to the set of part of source speech labels or (ii) the set of target syllables.

The target syntactic feature or the target semantic feature may involve a part of speech rule for the target language. The target syntactic feature or the target semantic feature may involve a complexity formula for the target language. For example, the complexity formula can be generic to target languages or one target language may have one complexity formula and another target language may have another complexity formula. The target syntactic feature or the target semantic feature may involve a readability formula (e.g., Flesch-Kincaid, Gunning-Fog, SMOG, RIX, LIX) for the target language. For example, the readability formula can be generic to target languages or one target language may have one readability formula and another target language may have another readability formula. The target syntactic feature or the target semantic feature may involve a measure of similarity to a historical target descriptive text for the target language (e.g., a baseline target descriptive text). The target syntactic feature or the target semantic feature may involve the set of target syllables satisfying or not satisfying a target syllable threshold for the target language. Note that syllabization is one of many linguistic features that may be additionally or alternatively used, where some, most, or all of which may or may not be common with linguistic features disclosed in context of FIGS. 7-18. There may be thresholds for each part of speech. For example, a threshold may be satisfied (pass) based on syllabization, but not satisfied (fail) on number of nouns, although satisfaction or non-satisfaction may be vice versa. Some examples of such features include adjectives, nouns, proper nouns, word count, long words, numbers, punctuations, or other suitable features.

The actions include labeling (e.g., flagging, associating, referencing, pointing, semaphoring) the target descriptive text with a target pass label based on the target descriptive text threshold being satisfied or a target fail label based on the target descriptive text threshold not being satisfied. Therefore, the target workflow decision is formed based on the target descriptive text being labeled with the target pass label or the target fail label. Note that when the step 304 and the step 308 is performed by the common API, then the common API can identically profile the source descriptive text recited in the source language and the target descriptive text recited in the target language while accounting for differences between the source language and the target language.

In step 310, the application program 202 routes the target descriptive text to the third sub-workflow responsive to the target workflow decision being formed based on the target descriptive text being labeled with the target pass label (e.g., ready for consumption) or the fourth sub-workflow responsive to the target workflow decision being formed based on the target descriptive text being labeled with the target fail label (e.g., ready for quality review). Therefore, this enables a targeted LQA if warranted in case of a potential translation quality fail based on the target fail label.

The third sub-workflow may involve a presentation of a document area (e.g., a text edit screen) presenting the target descriptive text recited in the target language for a subject matter expert review (e.g., a technologist) and validation (e.g., by activating an element of a user interface). The third sub-workflow may involve a desktop publishing action (e.g., converting the target descriptive text recited in the target language into a preset template or format) to enable the source descriptive text recited in the target language to be published or prepared for publication. The third sub-workflow may involve sending the target descriptive text recited in the target language to a user device (e.g., the text source terminal 108) external to the computing instance 104 for an end use (e.g., consumption, comprehension, review) of the target descriptive text. The third sub-workflow may include a sequence of actions that vary depending on (i) a type of a file containing the source descriptive text or the target descriptive text and (ii) an identifier for an entity submitting the source descriptive text for translation to the target descriptive text. This may enable customization based on file type or user.

The fourth sub-workflow may involve sending the target descriptive text to a user device (e.g., the translator terminal 110) external to the computing instance 104 for a linguistic user edit of the target descriptive text, which may be through the editor user profile via the editor terminal 112. The fourth sub-workflow may involve a machine-based evaluation of a linguistic quality of the target descriptive text recited in the target language according to a set of predetermined criteria to inform an end user thereof (e.g., the text source terminal 108). The fourth sub-workflow may include a sequence of actions that vary depending on (i) a type of a file containing the source descriptive text or the target descriptive text and (ii) an identifier for an entity submitting the source descriptive text for translation to the target descriptive text. This may enable customization based on file type or user.

When used, this unconventional approach is technologically beneficial because various NLP techniques are used as an automated workflow decision-driving mechanism in accurately managing workflows of files (e.g., data files, text files, productivity files) on enterprise scale, including for the targeted LQA process, in contrast to a conventional approach of having various content transformation decisions being made manually by a human actor. Such technological benefits increase computational efficiency, decrease network latency, expedite speed of translations, and improve translation quality, while simultaneously being more cost-effective and less laborious than the conventional approach. For example, when content (e.g., a descriptive text, an unstructured text) is routed for machine translation even though such content is not suited for machine translation, there are significant additional post-editing manual translation efforts, which are time-consuming and laborious, while also being wasteful in computational cycles and network bandwidth. Therefore, the unconventional approach noted above minimizes or eliminates these significant additional post-editing manual translation efforts. Likewise, unlike random content selection or oversampling for the targeted LQA process, the unconventional approach noted above enables or maximizes targeted search for “real” poor quality candidates, which leads to significant reduction of time and labor for the targeted LQA process, while being efficient in computational cycles and network bandwidth. Additionally, this unconventional approach enables a form of visual presentation informative of performed linguistic feature analysis, a corresponding workflow recommendation, and a corresponding recommendation on the scope of the LQA process performed, especially with the ability to drill down into this visual presentation.

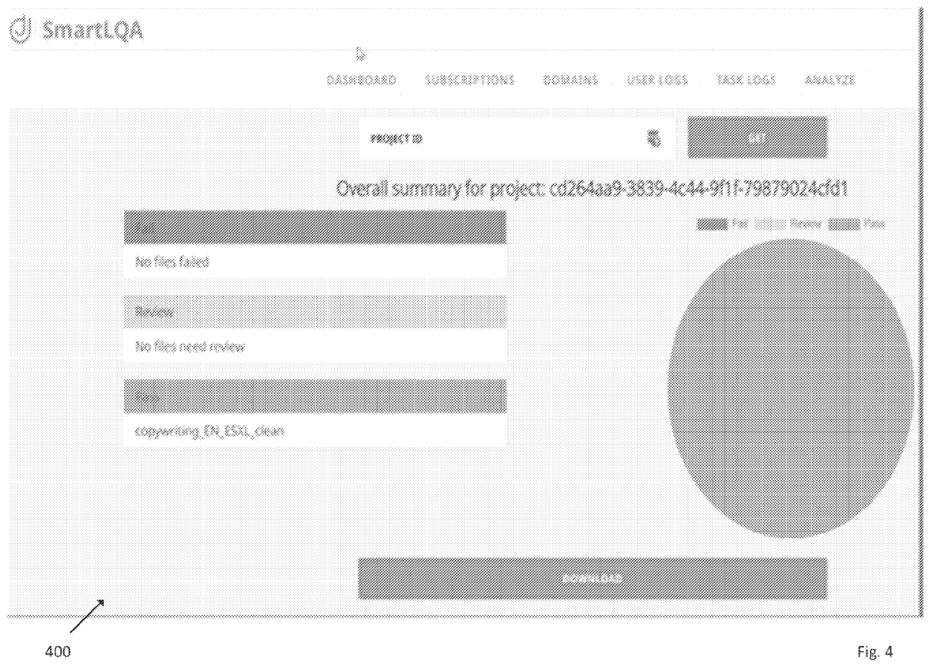

In step 312, the application program 202 takes an action based on the third sub-workflow or the fourth sub-workflow. The actions can be of various types. For example, the action may include presenting a form of visual presentation informative of performed linguistic feature analysis, a corresponding workflow recommendation, and a corresponding recommendation on the scope of the LQA process performed, as shown in FIG. 4. The form of visual presentation may have with an ability to present a drill down data into this form of visual presentation. However, note that other actions are possible.

Note that the application program 202 may contain a configuration file that is specific to a user profile associated with the text source terminal 108 and a domain (e.g., marketing documentation, technical documentation, legal documentation, contractual documentation, training documentation, product documentation) associated with the user profile. In other situations, the configuration may be stored external to the application program 202 and the application program 202 may accordingly access the configuration file. Regardless, the configuration file can include a set of parameters to be read by the application program 202 to process according or based on the configuration file. For example, the configuration file can be an executable file, a data file, a text file, a delimited file, a comma separated values file, an initialization file, or another suitable file or another suitable data structure. For example, the configuration file can include a JavaScript Object Notation (JSON) content or another file format or data interchange format that uses human-readable text to store and transmit data objects consisting of attribute-value pairs and arrays (or other serializable values). For example, the configuration file can include a set of parameters recited below on a per user profile, domain, and language basis.

```
{
  “client”: “dell”,
  “domain”: “default”,
  “languages”: [
    {
      “name”: “en”,
      “featurelist”: {
      “ADJ Count Status”: [3, 0.05],
      “NOUN Count Status”: [4, 0.15],
      “PROPN Count Status”: [3, 0.10],
      “Long Word Count Status”: [4, 0.05],
      “Complex Word Count Status”: [4, 0.05],
      “Nominalization Count Status”: [1, 0.05],
      “Word Count Status”: [20, 0.25],
      “FleschReadingEase Status”: [50, 0.3],
      “LM Score Status”: [0],
      “LIX Status”: [0]
      }
    },
      {
      “name”: “de”,
      “featurelist”: {
      “ADJ Count Status”: [3, 0.1],
      “NOUN Count Status”: [4, 0.2],
      “PROPN Count Status”: [3, 0.1],
      “Long Word Count Status”: [4, 0.05],
      “Complex Word Count Status”: [0],
      “Nominalization Count Status”: [0],
      “Word Count Status”: [20, 0.25],
      “FleschReadingEase Status”: [0],
      “LM Score Status”: [0],
      “LIX Status”: [50, 0.3]
      }
    },
    {
      “name”: “es”,
      “featurelist”: {
      “ADJ Count Status”: [3, 0.1],
      “NOUN Count Status”: [4, 0.2],
      “PROPN Count Status”: [3, 0.1],
      “Long Word Count Status”: [4, 0.05],
      “Complex Word Count Status”: [0],
      “Nominalization Count Status”: [0],
      “Word Count Status”: [20, 0.25],
      “FleschReadingEase Status”: [0],
      “LM Score Status”: [0],
      “LIX Status”: [50, 0.3]
      }
    },
    {
      “name”: “fr”,
      “featurelist”: {
      “ADJ Count Status”: [3, 0.1],
      “NOUN Count Status”: [4, 0.2],
      “PROPN Count Status”: [3, 0.1],
      “Long Word Count Status”: [4, 0.05],
      “Complex Word Count Status”: [0],
      “Nominalization Count Status”: [0],
      “Word Count Status”: [20, 0.25],
      “FleschReadingEase Status”: [0],
      “LM Score Status”: [0],
      “LIX Status”: [50, 0.3]
      }
    },
    {
      “name”: “ja”,
      “featurelist”: {
      “ADJ Count Status”: [3, 0.10],
      “NOUN Count Status”: [4, 0.2],
      “PROPN Count Status”: [3, 0.1],
      “Long Word Count Status”: [0],
      “Complex Word Count Status”: [0],
      “Nominalization Count Status”: [0],
      “Word Count Status”: [45, 0.4],
      “FleschReadingEase Status”: [0],
      “LM Score Status”: [0],
      “LIX Status”: [0]
      }
    },
    {
      “name”: “pt”,
      “featurelist”: {
      “ADJ Count Status”: [3, 0.1],
      “NOUN Count Status”: [4, 0.2],
      “PROPN Count Status”: [3, 0.1],
      “Long Word Count Status”: [4, 0.05],
      “Complex Word Count Status”: [0],
      “Nominalization Count Status”: [0],
      “Word Count Status”: [20, 0.25],
      “FleschReadingEase Status”: [0],
      “LM Score Status”: [0],
      “LIX Status”: [50, 0.3]
      }
    },
    {
      “name”: “cn”,
      “featurelist”: {
      “ADJ Count Status”: [3, 0.1],
      “NOUN Count Status”: [4, 0.2],
      “PROPN Count Status”: [3, 0.1],
      “Long Word Count Status”: [0],
      “Complex Word Count Status”: [0],
      “Nominalization Count Status”: [0],
      “Word Count Status”: [39, 0.4],
      “FleschReadingEase Status”: [0],
      “LM Score Status”: [0],
      “LIX Status”: [0]
      }
    },
      {
      “name”: “xx”,
      “featurelist”: {
      “ADJ Count Status”: [4],
      “NOUN Count Status”: [4],
      “PROPN Count Status”: [4],
      “Long Word Count Status”: [4],
      “Complex Word Count Status”: [0],
      “Nominalization Count Status”: [0],
      “Word Count Status”: [25],
      “FleschReadingEase Status”: [0],
      “LM Score Status”: [0],
      “LIX Status”: [50]
      }
    }
  ]
}
```

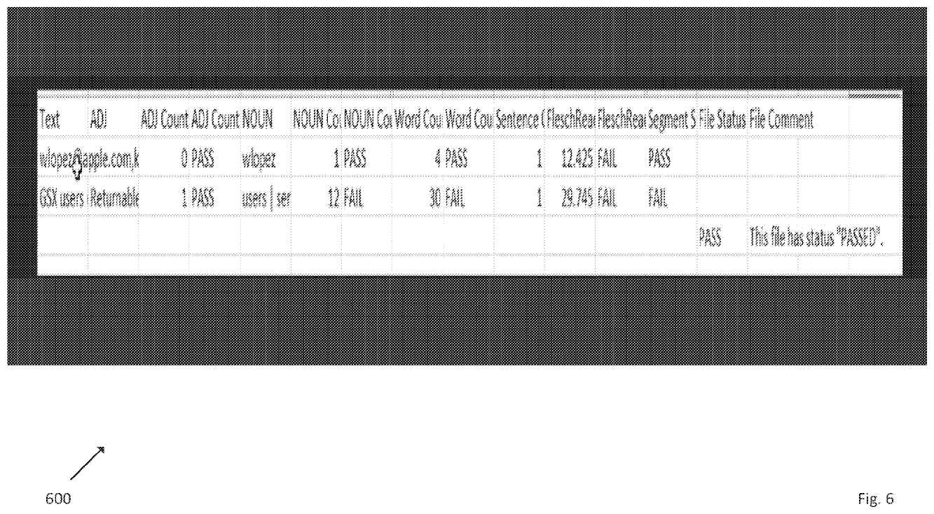

The configuration file may contain parameters for salient features and weights on a per language basis to be used in processing of the source or target descriptive text by the application program 202, as disclosed herein. The parameters for salient features and weights differ on a per language basis and are permissioned to be customizable by the user profile. For example, various thresholds, as disclosed herein, may or may not be satisfied against the configuration file, which may function as a customizable threshold baseline. Accordingly, as shown in FIG. 6, the application program 202 determines salient features on a sentence pass/fail level for the source or target descriptive text, as disclosed herein. In addition, at the source or target descriptive text level (e.g., a file level), if more than 40% of individual salient features fail (or other lower or higher set threshold) at the source or target descriptive text level, then the source or target descriptive text may be considered (e.g., labeled, flagged, semaphored, identified) high complexity by the application program 202; if between 15-39% of individual salient features fail at the source or target descriptive text level, then the source or target descriptive text is considered (e.g., labeled, flagged, semaphored, identified) medium complexity by the application program 202; and below 15% of individual salient features fail at the source or target descriptive text level, then the source or target descriptive text is considered (e.g., labeled, flagged, semaphored, identified) low complexity by the application program 202. Resultantly, when there is a heatmap for each language used in processing or preparing the source or target descriptive text, as disclosed herein, then such heatmap may be based on the salient features and thresholds for that particular language, domain and client and will differ for English versus Russian versus French (or other source or target languages). The heatmap may be based on a set of data populated in a table shown in FIG. 6 based on the application program 202 processing the source or target descriptive text, as disclosed herein.

FIG. 4 shows an embodiment of a dashboard with a summary of linguistic feature analysis, workflow recommendation and recommendation on a scope of LQA according to this disclosure. In particular, the application program 202 presents a dashboard 400 on the text source terminal 108 via the text source user profile through the web browser of the text source terminal 108 over the network 102. The dashboard 500 shows a unique identifier associated with the source descriptive text recited in the source language and the target descriptive text recited in the target language. This allows for job tracking and corresponding workflow management. The dashboard 500 shows a color-coded diagram (e.g., implying a confidence rating by color) for the target descriptive text recited in the target language as to whether the target descriptive text recited in the target language satisfied desired LQA thresholds to be consumed by an end user (e.g., the text source terminal 108 via the text source user profile through the web browser of the text source terminal 108 over the network 102). If so (e.g., green color), then the end user may download a file (e.g., a productivity suite file, a word processing software file) containing the target descriptive text recited in the target language. However, if not (e.g., yellow color or red color), then end user may have an option (e.g., by activating an element of an API endpoint) to route the target descriptive text recited in the target language for further LQA (e.g., the translator terminal 110) or download the target descriptive text recited in the target language as is.

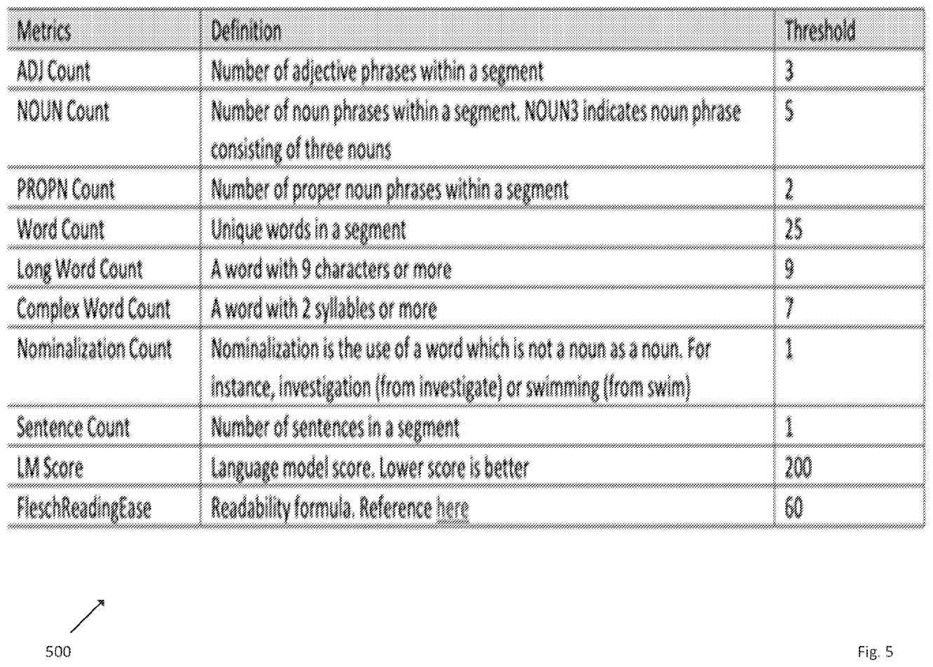

FIG. 5 shows an embodiment of a screen for drill-down data of the dashboard of FIG. 4 according to this disclosure. In particular, based on the process 300, the application program 202 prepares a set of drilldown data according to which the dashboard 400 is color-coded and enables the dashboard 400 to present (e.g., internally or externally) a table 500. The table 500 is populated with the set of drilldown data based on which the dashboard 400 is color-coded so that the end user (e.g., the text source terminal 108 via the text source user profile through the web browser of the text source terminal 108 over the network 102) can understand why the dashboard 400 is color-coded as is. Therefore, FIG. 4 and FIG. 5 enable the end user to visualize the dashboard 400 with a summary of linguistic feature analysis, workflow recommendation (e.g., use or no use of machine translation) and recommendation on scope of LQA, with an ability to be further drilled into for individual file or segment level.

FIG. 7 shows a schematic diagram of an embodiment of an application program from FIG. 1 to evaluate linguistic content to predict impact on a set of user engagement analytic parameters to route an unstructured text between an editing user interface and a translation user interface according to this disclosure. In particular, the application program 202 has an architecture 700 including an unstructured text (e.g., an article, a legal document, a contract, a patent specification) with a set of linguistic features 702 (e.g., an article, a legal document, a contract, a patent specification), an identifier of a target language 704 (e.g., English, Russian, Spanish, Mandarin. Cantonese, Korean, Japanese, Hindi, Arabic, Hebrew), a binary file 706, a machine learning model 708, an editing user interface 710, and a translation user interface 712, where some, most, or all of these components which may be operative together with the architecture 200 to implement various technologies disclosed herein. For example, the architecture 700 may include or exclude the architecture 200 or the predetermined workflow 204. For example, the unstructured text with the set of linguistic features 702 may be employed together with the identifier of the target language 704 to enable translation of the unstructured recited in the source language to the target language with potential edit input via the editing user interface 710 or potential translation input via the translation user interface 712 based on the machine learning model 708 as disclosed herein.

The unstructured text with the set of linguistic features 702, the identifier of the target language 704, the editing user interface 710 and the translation user interface 712 are external to the binary file 706 within the application program 202. The unstructured text with the set of linguistic features 702 and the identifier of the target language 704 are received from a data source over the network 102, which may be the text source terminal 108, as disclosed herein. Some examples of some linguistic features present in the unstructured text recited in the source language are described above and may include an abbreviation definition, a number of adjectives, a number of adpositions, a number of numerals, a number of particles, a number of adverbs, a number of pronouns, a number of auxiliaries, a number of proper nouns, a number of coordinating conjunctions, a number of punctuations, a number of determiners, a number of subordinating conjunctions, a number of interjections, a number of symbols, a number of nouns, a number of verbs, a language model score, an adjective/noun density, a number of syllables, a number of unique words, a number of complex words, a number of long words, a maximum similarity scoring, a mean similarity scoring, a readability formulate or score, a number of words in a sentence, a number of nominalizations, or other suitable linguistic features described above or below.

Although the identifier of the target language 704 is separate and distinct from the unstructured text with the set of linguistic features 704, this is not required and the unstructured text with the set of linguistic features 704 may contain the identifier of the target language 704 for the application program 202 to identify (e.g., string in target language, font type, font size, color, encoded string, image, barcode) for translational processing, as disclosed herein. Although the editing user interface 710 and the translation user interface 712 are separate and distinct from each other and do not share functionality, this is not required and the editing user interface 710 and the translation user interface 712 may have some functional overlap (e.g., same buttons, same document area) or be a single user interface.

The machine learning model 708 is contained within the binary file 706, which enables efficient memory storage and efficient speed of access. However, this is not required and other file types may be used.

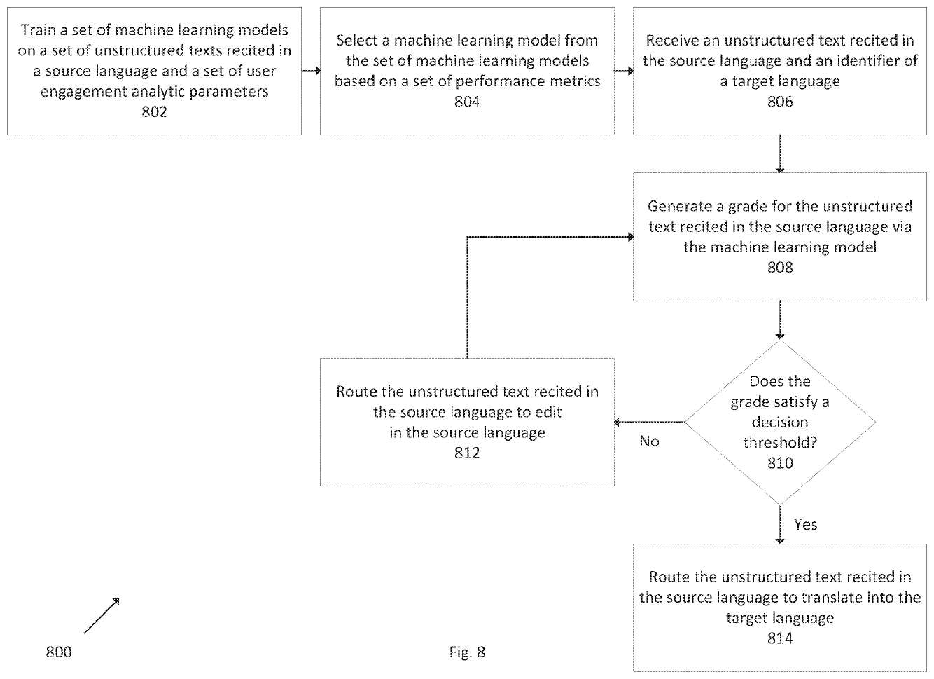

FIG. 8 shows a flowchart of an embodiment of a process to operate the application program of FIG. 7 to evaluate linguistic content to predict impact on a set of user engagement analytic parameters to route an unstructured text between an editing user interface and a translation user interface according to this disclosure. In particular, a process 800 includes steps 802-814 includes steps 802-814, which are performed via the computing architecture 100 and the architecture 700, as disclosed herein.

In step 802, the application program 202 (or another suitable logic running on the computing instance 104) trains (e.g., via Python or other libraries that employ machine learning algorithms) a set of machine learning models on a set of unstructured texts recited in a source language and a set of user engagement analytic parameters. As further explained below, this training occurs by a set of supervised machine learning algorithms (e.g., a classification algorithm, a linear regression algorithm). The set of unstructured texts is recited in the source language (e.g., English, Russian, Spanish, Arabic, Cantonese, Hebrew) and contains the set of linguistic features.

Some examples of such linguistic features are described above and may include an abbreviation definition, a number of adjectives, a number of adpositions, a number of numerals, a number of particles, a number of adverbs, a number of pronouns, a number of auxiliaries, a number of proper nouns, a number of coordinating conjunctions, a number of punctuations, a number of determiners, a number of subordinating conjunctions, a number of interjections, a number of symbols, a number of nouns, a number of verbs, a language model score, an adjective/noun density, a number of syllables, a number of unique words, a number of complex words, a number of long words, a maximum similarity scoring, a mean similarity scoring, a readability formulate or score, a number of words in a sentence, a number of nominalizations, or other suitable linguistic features described above or below, each on a per sentence, a set of sentences, a set of consecutive sentences, or the unstructured text as a whole basis, where alone or as a combination involving at least two. These features provide various technical benefits due to ability to process various types of unstructured text. As such, at least one, two, three, four, five, six, seven, eight, nine, ten, or more of these features can be used simultaneously.

The set of user engagement analytic parameters is measured in advance for each member of the set of unstructured texts for each member of the set of machine learning models to respectively correlate how the set of linguistic features identified in that member of the set of unstructured texts is predicted to respectively impact the set of user engagement analytic parameters. Some examples of such user engagement analytic parameters include a user satisfaction parameter, a click-through rate parameter, a view rate parameter, a conversion rate parameter, a time period spent on a web page parameter, or other suitable user engagement analytic parameters. These user engagement analytic parameters provide various technical benefits due to ability to capture various types of user behavior in context of the set of unstructured texts. As such, at least one, two, three, four, five, or more of these parameters can be used simultaneously each on a per sentence, a set of sentences, a set of consecutive sentences, or the unstructured text as a whole basis, where alone or as a combination involving at least two. As such, this training enables each member of the set of machine learning models to correlate how the set of linguistic features identified in a particular unstructured text is predicted to impact at least those user engagement analytic parameters.

The set of user engagement analytic parameters may be stored in a delimited format (e.g., a comma separated values format, a tab separated values format). As such, the set of machine learning models may be trained by the set of supervised machine learning algorithms on (i) the set of unstructured texts recited in the source language and containing the set of linguistic features and (ii) the set of user engagement analytic parameters measured for the set of unstructured texts to correlate how the set of linguistic features identified in the set of unstructured texts is predicted to impact the set of user engagement analytic parameters based on reading the set of user engagement analytic parameters in the delimited format and confirming that each user engagement analytic parameter in the set of user engagement analytic parameters corresponds to at least one linguistic feature in the set of linguistic features identified in the set of unstructured texts. If such correspondence is absent or cannot be made, then the computing instance 104 may take an action responsive to at least one user engagement analytic parameter in the set of user engagement analytic parameters not corresponding to at least one linguistic feature in the set of linguistic features identified in the unstructured texts. The action may include presenting a visual notice to a user profile at a user terminal accessing the computing instance 104 over the network 102, which may be the administrator profile at the administrator terminal 106 (or not the editor user profile or not the translator user profile). The user profile may have a write file permission to the set of unstructured texts, the set of user engagement analytic parameters, and the set of machine learning models.

As further explained below, the set of machine learning models may be trained by the set of supervised machine learning algorithms based on mutual information between the set of linguistic features identified in the set of unstructured texts and the set of user engagement analytic parameters measured for the set of unstructured texts to correlate how the set of linguistic features identified in the set of unstructured texts is predicted to impact the set of user engagement analytic parameters. Likewise, as further explained below, the machine learning model may be selected based on the set of performance metrics including at least one of a confusion matrix, a precision metric, a recall metric, an accuracy metric, a receiver operating characteristic (ROC) curve, or precision recall (PR) curve.

In step 804, the application program 202 (or another suitable logic running on the computing instance 104) selects the machine learning model 708 from the set of machine learning models based on a set of performance metrics, as further described below. Once selected, the machine learning model 708 is input into the binary file 706, as further described below. As such, the application program 202 includes the binary file 706 containing the machine learning model 708. Therefore, the application program 202 is now programmed to correlate how the set of linguistic features identified in the set of unstructured texts is predicted to impact the set of user engagement analytic parameters.

The machine learning model 708 is selected from the set of machine learning models, where each member of the set of machine learning models is trained for a single specific source language using (i) the set of unstructured texts each recited in the source language and (ii) the set of user engagement analytic parameters, as disclosed herein. For example, each member in the set of machine learning models may be trained for Russian (or another source language) and the machine learning model 708 is selected from the set of machine learning models based on the set of performance metrics, as disclosed herein. However, since source languages may be linguistically different from each other (e.g., structure, semantics, morphology), there may be multiple sets of machine learning models, where each of such sets corresponds to a single specific source language, as disclosed herein. For example, there may be a set of machine learning models for English, a set of machine learning models for Italian, a set of machine learning models for Arabic, a set of machine learning models for Spanish, and so forth, as needed. Therefore, there may be a machine learning model 708 selected from each of such sets for a respective single specific source language. For example, the machine learning model 708 may be selected from the set of machine learning models for English, the machine learning model 708 may be selected from the set of machine learning models for Italian, the machine learning model 708 may be selected from the set of machine learning models for Arabic, the machine learning model 708 may be selected from the set of machine learning models for Spanish, and so forth, as needed, i.e., there may be multiple machine learning models 708 stored in a single binary file 706 or multiple binary files 706. Correspondingly, these selections may be done based on the set of performance metrics used for several specific source languages or each specific source language may have its own set of performance metrics. Regardless, for each source language, the computing instance 104 or the application program 102 (or another suitable logic) may host a machine learning model 708, each trained on that respective source language and then selected from a larger set of machine learning models for that specific source language. Therefore, there may be situations where some data sources, which may include some text source terminals 108, are associated with some machine learning models 708 and not others based on various technologies disclosed herein.

Note that the application program 202 has the editor user profile accessed from the editor terminal 112 and the translator user profile accessed from the translator terminal 110. The editor profile includes an editor language setting (e.g., English), which the application program 202 uses to track which language the editor user profile is capable of editing. Further, the application program 202 has the translator user profile, which includes a first translator language setting (e.g., English) and a second translator language setting (e.g., Russian), each of which is used by the application program 202 to track which language the translator user profile is capable of translating between.

In block 806, the application program 202 (or another suitable logic running on the computing instance 104) receives the unstructured text with the set of linguistic features 702 and the identifier of the target language 704 from the data source, which may be the text source terminal 108 over the network 102. The unstructured text with the set of linguistic features 702 is not present in the set of unstructured texts on which the machine learning model 708 was trained. Therefore, the machine learning model 708 is not trained on the unstructured text with the set of linguistic features 702. The unstructured text with the set of linguistic features 702 is recited in the source language (e.g., Russian). The identifier of the target language 704 indicates which language the unstructured text with the set of linguistic features 702 should be translated to (e.g. English).

In block 808, the application program 202 (or another suitable logic running on the computing instance 104) reads the binary file 706 and generates a grade for the unstructured text with the set of linguistic features 702 via the machine learning model 708. The grade correlates how the set of linguistic features identified in the unstructured text is predicted to impact the set of user engagement analytic parameters for the unstructured text. The grade can be a letter (e.g., A, B, C), a score (e.g., 80 out 100), a set of ranges (e.g., 0-5 and 6-10), a scale (e.g., 0-10), a Likert scale, a point on a continuum, or any other suitable form of opining on the unstructured text with the set of linguistic features 702.

The application program 202 (or another suitable logic running on the computing instance 104) may identify what source language is dominant in the unstructured text with the set of linguistic features 702 (e.g., a majority or minority analysis) to determine what machine learning model 708 to select for grading the unstructured text with the set of linguistic features 702, if the application program 202 (or another suitable logic running on the computing instance 104) stores multiple machine learning models 708 corresponding to multiple source languages, as disclosed herein. In those situations, the grade may be generated based on what dominant source language text (e.g., majority) is present in the unstructured text with the set of linguistic features 702. However, in some embodiments, the grade may be generated on non-dominant source language text (e.g., minority) in the unstructured text with the set of linguistic features 702 as well and then those two grades (dominant grade and non-dominant grade) or more (if two or more non-dominant source languages are present) may be aggregated into a single grade for the unstructured text (e.g., based on averaging, ratios of dominant to non-dominant text).

In block 810, the application program 202 (or another suitable logic running on the computing instance 104) determines whether the grade satisfies a decision threshold associated with how the set of linguistic features identified in the unstructured text is predicted to impact the set of user engagement analytic parameters. For example, the grade may correlate how the set of linguistic features identified in the unstructured text is predicted to impact the set of user engagement analytic parameters based on sentence embeddings (or other features in the machine learning model 708 that may impact the grade and thus impact the set of user engagement analytic parameters) to measure stylistic similarity or dissimilarity to the set of unstructured texts (e.g., via a HuggingFace generic or customized model). If the grade does not satisfy the decision threshold, then step 812 is performed. If the grade does satisfy the decision threshold, then step 814 is performed.

In step 812, the application program 202 (or another suitable logic running on the computing instance 104) routes the unstructured text with the set of linguistic features 702 within the computing instance 104 such that the unstructured text with the set of linguistic features 702 is assigned to the editor profile based on the editor language setting corresponding to the source language detected in the unstructured text with the set of linguistic features 702. This would indicate that the editor profile is capable of editing the unstructured text with the set of linguistic features 702 from the editor terminal 112 over the network 102. Then, once the unstructured text with the set of linguistic features 702 is assigned to the editor profile, the unstructured text with the set of linguistic features 702 is edited from the editor terminal to satisfy the decision threshold based on a corrective content.

The corrective content is generated by the application program 202 (or another suitable logic running on the computing instance 104) when (e.g., before, during, after) the application program 202 (or another suitable logic running on the computing instance 104) generated the grade for the unstructured text with the set of linguistic features 702 via the machine learning model 708. The corrective content is presented by the application program 202 (or another suitable logic running on the computing instance 104) to the editor profile to be visualized at the editor terminal such that the unstructured text with the set of linguistic features 702 as edited via the editor profile from the editor terminal based on the corrective content can be or is again (iteratively) input into the application program 202 (or another suitable logic running on the computing instance 104) for the application program 202 (or another suitable logic running on the computing instance 104) to read the binary file 706, generate the grade for the unstructured text with the set of linguistic features 702 as edited via the editor profile from the editor terminal based on the corrective content via the machine learning model 708, and satisfy the decision threshold. Note that this is not an endless loop. Therefore, the editor profile may have an option at the application program 202 (or another suitable logic running on the computing instance 104) to decline or skip inputting or selecting to input the unstructured text with the set of linguistic features 702 as edited via the editor profile from the editor terminal based on the corrective content into the application program 202 (or another suitable logic running on the computing instance 104) to again grade the unstructured text with the set of linguistic features 702 as edited via the editor profile from the editor terminal based on the corrective content and potentially receive more corrective content. Alternatively, the application program 202 (or another suitable logic running on the computing instance 104) may halt this iterative process after a certain amount of loops (e.g., five, ten) or issue a notice (e.g., a message, a log entry) to the administrator profile accessing the computing instance via the terminal 106 over the network 102.

As explained above, the set of user engagement analytic parameters on which the machine learning model 708 was trained may include at least one of the user satisfaction parameter, the click-through rate parameter, the view rate parameter, the conversion rate parameter, the time period spent on the web page parameter, or other suitable user engagement analytic parameters. As such, the grade issued via the machine learning model 708 may correlate how the set of linguistic features identified in the unstructured text is predicted to impact at least one of the user satisfaction parameter, the click-through rate parameter, the view rate parameter, the conversion rate parameter, the time period spent on the web page parameter, or other suitable user engagement analytic parameters. For example, a higher grade may indicate more correlation with some, many, most, or all of the set of user engagement analytic parameters, with a lower grade being opposite, or vice versa. Therefore, the corrective content is generated by the application program 202 (or another suitable logic running on the computing instance 104) may be based on improving (e.g., increasing, decreasing) at least the one of the user satisfaction parameter, the click-through rate parameter, the view rate parameter, the conversion rate parameter, the time period spent on the web page parameter, or other suitable user engagement analytic parameters.

The corrective content can be generated by the application program 202 (or another suitable logic running on the computing instance 104) based on at least one linguistic feature from the set of linguistic features. For example, the corrective content can be generated by the application program 202 (or another suitable logic running on the computing instance 104) at least based on a number of nouns per sentence, a set of sentences, a set of consecutive sentences, or the unstructured text as a whole as identified in the unstructured text with the set of linguistic features 702 recited in the source language. This generation occurs such that the unstructured text with the set of linguistic features 702 as edited via the editor profile from the editor terminal 112 based on the corrective content impacts at least the number of nouns per sentence, the set of sentences, the set of consecutive sentences, or the unstructured text as the whole to be again input into the application program 202 (or another suitable logic running on the computing instance 104) to be graded via the machine learning model 708. Therefore, the application program 202 (or another suitable logic running on the computing instance 104) can again read the binary file 706, generate the grade for the unstructured text with the set of linguistic features 702 as edited via the editor profile from the editor terminal 112 based on the corrective content to impact at least the number of nouns per sentence, the set of sentences, the set of consecutive sentences, or the unstructured text as the whole via the machine learning model 708, and satisfy the decision threshold based on impacting at least the number of nouns per sentence, the set of sentences, the set of consecutive sentences, or the unstructured text as the whole.

If the decision threshold is not again satisfied, then the unstructured text with the set of linguistic features 702 as edited via the editor profile from the editor terminal 112 based on the corrective content impacting at least the number of nouns per sentence, the set of sentences, the set of consecutive sentences, or the unstructured text as the whole can be again similarly edited, i.e., to loop. However, as explained above, note that this is not an endless loop. Therefore, the editor profile may have an option at the application program 202 (or another suitable logic running on the computing instance 104) to decline or skip inputting or selecting to input the unstructured text with the set of linguistic features 702 as edited via the editor profile from the editor terminal based on the corrective content into the application program 202 (or another suitable logic running on the computing instance 104) to again grade the unstructured text with the set of linguistic features 702 as edited via the editor profile from the editor terminal based on the corrective content and potentially receive more corrective content. Alternatively, the application program 202 (or another suitable logic running on the computing instance 104) may halt this iterative process after a certain amount of loops (e.g., five, ten) or issue a notice (e.g., a message, a log entry) to the administrator profile accessing the computing instance via the terminal 106 over the network 102.

Although the corrective content can be generated by the application program 202 (or another suitable logic running on the computing instance 104) at least based on a number of nouns per sentence, a set of sentences, a set of consecutive sentences, or the unstructured text as a whole as identified in the unstructured text with the set of linguistic features 702 recited in the source language, there are other linguistic features based on which the application program 202 (or another suitable logic running on the computing instance 104 can generate the corrective content. Some of these linguistic features are described above and include a score of a readability formula applied to the unstructured text (e.g., Flesch-Kincaid, Gunning-Fog, SMOG, RIX, LIX); a nominalization frequency per sentence, a set of sentences, a set of consecutive sentences, or the unstructured text as a whole measured for the unstructured text; a number of words exceeding a predetermined length per sentence, a set of sentences, a set of consecutive sentences, or the unstructured text as a whole identified in the unstructured text; a word count per sentence, a set of sentences, a set of consecutive sentences, or the unstructured text as a whole counted in the unstructured text; an abbreviation definition identified in the unstructured text; a number of adjectives per sentence, a set of sentences, a set of consecutive sentences, or the unstructured text as a whole identified in the unstructured text; a number of adpositions per sentence, a set of sentences, a set of consecutive sentences, or the unstructured text as a whole identified in the unstructured text; a number of numerals per sentence, a set of sentences, a set of consecutive sentences, or the unstructured text as a whole identified in the unstructured text; a number of particles per sentence, a set of sentences, a set of consecutive sentences, or the unstructured text as a whole identified in the unstructured text; a number of adverbs per sentence, a set of sentences, a set of consecutive sentences, or the unstructured text as a whole identified in the unstructured text; a number of pronouns per sentence, a set of sentences, a set of consecutive sentences, or the unstructured text as a whole identified in the unstructured text; a number of auxiliaries per sentence, a set of sentences, a set of consecutive sentences, or the unstructured text as a whole identified in the unstructured text; a number of proper nouns per sentence, a set of sentences, a set of consecutive sentences, or the unstructured text as a whole identified in the unstructured text; a number of coordinating conjunctions per sentence, a set of sentences, a set of consecutive sentences, or the unstructured text as a whole identified in the unstructured text; a number of punctuations per sentence, a set of sentences, a set of consecutive sentences, or the unstructured text as a whole identified in the unstructured text; a number of determiners per sentence, a set of sentences, a set of consecutive sentences, or the unstructured text as a whole identified in the unstructured text; a number of subordinating conjunctions per sentence, a set of sentences, a set of consecutive sentences, or the unstructured text as a whole identified in the unstructured text; a number of interjections per sentence, a set of sentences, a set of consecutive sentences, or the unstructured text as a whole identified in the unstructured text; a number of symbols (e.g., a logogram, a ligature, an ampersand, an at sign) per sentence, a set of sentences, a set of consecutive sentences, or the unstructured text as a whole identified in the unstructured text; a number of verbs per sentence, a set of sentences, a set of consecutive sentences, or the unstructured text as a whole identified in the unstructured text; a language model score generated for the unstructured text (e.g., a language model may be a file, a binary file, or another suitable file or data structure with probabilities of individual words or phrases (typically no more than 6 phrases) occurring next to each other; if a new text is analyzed, then the file provides a perplexity score where the lower the score the more the new text matches words or phrases in the same context as the old text, and the higher the score the less the new text matches words or phrases in the same context as the old text); an adjective-noun density per sentence, a set of sentences, a set of consecutive sentences, or the unstructured text as a whole identified in the unstructured text; a number of syllables per sentence, a set of sentences, a set of consecutive sentences, or the unstructured text as a whole identified in the unstructured text; a number of unique words (e.g., words that do not repeat within a specified text range) per sentence, a set of sentences, a set of consecutive sentences, or the unstructured text as a whole identified in the unstructured text; a number of complex words (e.g., words that are polysyllabic; 2 syllables or more are likely to have prefixes or suffixes added to a root word; if a word is not in its root form, then the word is considered complex) per sentence, a set of sentences, a set of consecutive sentences, or the unstructured text as a whole identified in the unstructured text; a number of long words (e.g., words containing 9 characters or more are considered long and thus may introduce additional cognitive load and/or complexity and may be less than 1000 characters) per sentence, a set of sentences, a set of consecutive sentences, or the unstructured text as a whole identified in the unstructured text; a maximum similarity scoring (e.g., words and ultimately sentences are represented numerically-embeddings in a vector space; historical data and plot sentences are captured into a vector space; if a new text is similar to the historical text, then the new text is considered less complex since this style was seen before; the opposite holds true as well, less similar means more complex since this style was not seen before; maximum similarity is the most similar historical sentence to each individual new sentence as measured by cosine similarity on a scale from 1-100; higher is more similar) per sentence, a set of sentences, a set of consecutive sentences, or the unstructured text as a whole generated on the unstructured text; a mean similarity scoring (e.g., words and ultimately sentences are represented numerically-embeddings in a vector space; historical data and plot sentences are captured into a vector space; if a new text is similar to a historical text, then the new text is considered less complex since this style was seen before; the opposite holds true as well, less similar means more complex since this style was not seen before; mean similarity is an average similarity of each historical sentence to each individual new sentence as measured by cosine similarity on a scale from 1-100; higher is more similar) per sentence, a set of sentences, a set of consecutive sentences, or the unstructured text as a whole generated on the unstructured text; a number of words per sentence, a set of sentences, a set of consecutive sentences, or the unstructured text as a whole identified in the unstructured text; a number of nominalizations per sentence, a set of sentences, a set of consecutive sentences, or the unstructured text as a whole identified in the unstructured text; or any other suitable linguistic feature. These features provide various technical benefits due to ability to process various types of unstructured text. As such, at least one, two, three, four, five, six, seven, eight, nine, ten, or more of these features can be used simultaneously. Note that although each of these linguistic features is described on a per sentence, a set of sentences, a set of consecutive sentences, or the unstructured text as a whole basis, this description includes only one of such basis or at least one of such basis, whether for FIG. 2-6 or 7-18.

The corrective content can be generated by the application program 202 (or another suitable logic running on the computing instance 104) to include text (e.g., according to the language setting of the editor profile), imagery (e.g., still graphics, videos, augmented reality), sound (e.g., tones, speech), or other content modalities. For example, the corrective content presented to the editor profile to be visualized at the editor terminal 112 may include a statistical report (e.g., a table or a listing populated with statistical data) outlining how the set of linguistic features identified in the unstructured text recited in the source language or the target language is predicted to impact the set of user engagement analytic parameters. Likewise, for example, the corrective content presented to the editor profile to be visualized at the editor terminal 112 may include a specific recommendation to the editor profile on editing the unstructured text with the set of linguistic features 702 in the source language via the editor profile from the editor terminal 112 to satisfy the decision threshold such that the unstructured text with the set of linguistic features 702 as edited via the editor profile from the editor terminal 112 based on the specific recommendation is again input into the application program 202 (or another suitable logic running on the computing instance 104) for the application program 202 (or another suitable logic running on the computing instance 104) to read the binary file 706, generate the grade for the unstructured text with the set of linguistic features 702 as edited via the editor profile from the editor terminal 112 based on the specific recommendation via the machine learning model 708, and satisfy the decision threshold. For example, there may be one specific recommendation for the set of linguistic features or the unstructured text (or a specific portion thereof) or there may be a set of specific recommendations for the set of linguistic features or the unstructured text (or a specific portion thereof). As such, the corrective content may function as a wizard or an iterative guide to direct the editor profile to edit the unstructured text (or a specific portion thereof) with the set of linguistic features 702 to satisfy the decision threshold. However, as explained above, note that this is not an endless loop. Therefore, the editor profile may have an option at the application program 202 (or another suitable logic running on the computing instance 104) to decline or skip inputting or selecting to input the unstructured text with the set of linguistic features 702 as edited via the editor profile from the editor terminal based on the corrective content into the application program 202 (or another suitable logic running on the computing instance 104) to again grade the unstructured text with the set of linguistic features 702 as edited via the editor profile from the editor terminal based on the corrective content and potentially receive more corrective content. Alternatively, the application program 202 (or another suitable logic running on the computing instance 104) may halt this iterative process after a certain amount of loops (e.g., five, ten) or issue a notice (e.g., a message, a log entry) to the administrator profile accessing the computing instance via the terminal 106 over the network 102.

The set of linguistic features may include a linguistic feature invoking a part of speech rule for the source language. As such, the grade may correlate how at least that linguistic feature identified in the unstructured text is predicted to impact the set of user engagement analytic parameters. Therefore, the corrective content may be generated by the application program 202 (or another suitable logic running on the computing instance 104) at least based on that linguistic feature. However, the linguistic feature may invoke a complexity formula for the source language, a readability formula for the source language, or a measure of similarity to a historical source unstructured text for the source language, whether additionally or alternatively.

The unstructured text with the set of linguistic features 702 can be stored in a data file (e.g., a productivity file, a DOCX file) when the computing instance 104 receives the data file over the network 102 from the data source, which may include the text source terminal 108. Therefore, as further explained below, the application program 202 (or another suitable logic running on the computing instance 104) can generate the grade for the unstructured text with the set of linguistic features 702 via the machine learning model 708 based on (i) forming a copy of the unstructured text with the set of linguistic features 702 from the data file based on confirming the data file not to be corrupt, (ii) converting the copy into a text-based format (e.g., a TXT format, a delimited format, a comma separated values format, a tab separated values format), and (iii) identifying the set of linguistic features in the text-based format such that the application program 202 (or another suitable logic running on the computing instance 104) reads the binary file 706 and generates the grade for the unstructured text via the machine learning model 708 based on the set of linguistic features identified in the text-based format.

In step 814, the application program 202 (or another suitable logic running on the computing instance 104) routes the unstructured text with the set of linguistic features 702 within the computing instance 104 based on the grade satisfying the decision threshold such that the unstructured text with the set of linguistic features 702 is assigned to the translator profile based on the first translator language setting corresponding to the source language detected in the unstructured text with the set of linguistic features 702 and the second translator language setting corresponding to the identifier of the target language 704. Then, the application program 202 (or another suitable logic running on the computing instance 104) enables the set of linguistic features 702 to be translated via the translator profile from the translator terminal 110 into the target language and sent to the data source to be end-used. This end-use may be monitored according to the set of user engagement analytic parameters. For example, this end-use can include generating a webpage containing the unstructured text translated into the target language and monitored according to the set of user engagement analytic parameters. Note that this is one example form of end-use and other suitable forms of end-use are possible. For example, other suitable forms of end-use may include inserting the unstructured text translated into the target language into an image, a help file, a database record, or another suitable data structure.

As explained above, optionally, based on the grade satisfying the decision threshold, the unstructured text with the set of linguistic features 702 may be translated in step 814 using various technologies described and shown in context of FIGS. 2-6. Therefore, the computing instance 104 may be programmed to route the unstructured text with the set of linguistic features 702 within the computing instance 104 based on the grade satisfying the decision threshold such that the unstructured text with the set of linguistic features 702 is translated via the translator profile from the translator terminal 110 into the target language corresponding to the identifier for the target language 704 via the computing instance 104 based on various techniques as described and shown in context of FIGS. 2-6.

In some embodiments, the process 800 can include a statistical correlation model (e.g., a measure of linear correlation between two sets of data, a Pearson correlation model) between the set of linguistic features and the set of user engagement analytic parameters and enable a reporting interface based on the statistical correlation model (e.g., a spreadsheet dashboard, a graph-type data visualizations). Therefore, the grade for the unstructured text with the set of linguistic features 702 can be implemented.

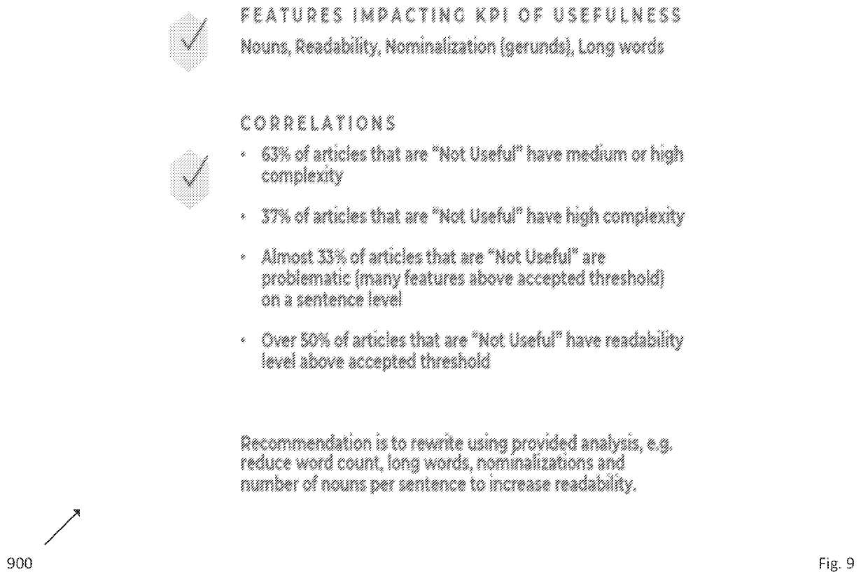

FIG. 9 shows a diagram of an embodiment of correlations between some linguistic features and some user engagement analytic parameters and a corrective content generated based thereon according to this disclosure. In particular, a diagram 900 indicates that some linguistic features, which include at least nouns, readability, nominalization, and long words (e.g., words that contain 9 characters or more but can include less than 1000 characters), may impact some user engagement analytic parameters, which may include usefulness parameters as user provided. Therefore, the corrective content may be generated to include a specific recommendation to rewrite that particular unstructured text to reduce word count, long words, nominalizations and number of nouns per sentence to increase readability measured by scores from certain readability formulas (e.g., Flesch-Kincaid, Gunning-Fog, SMOG, RIX, LIX).

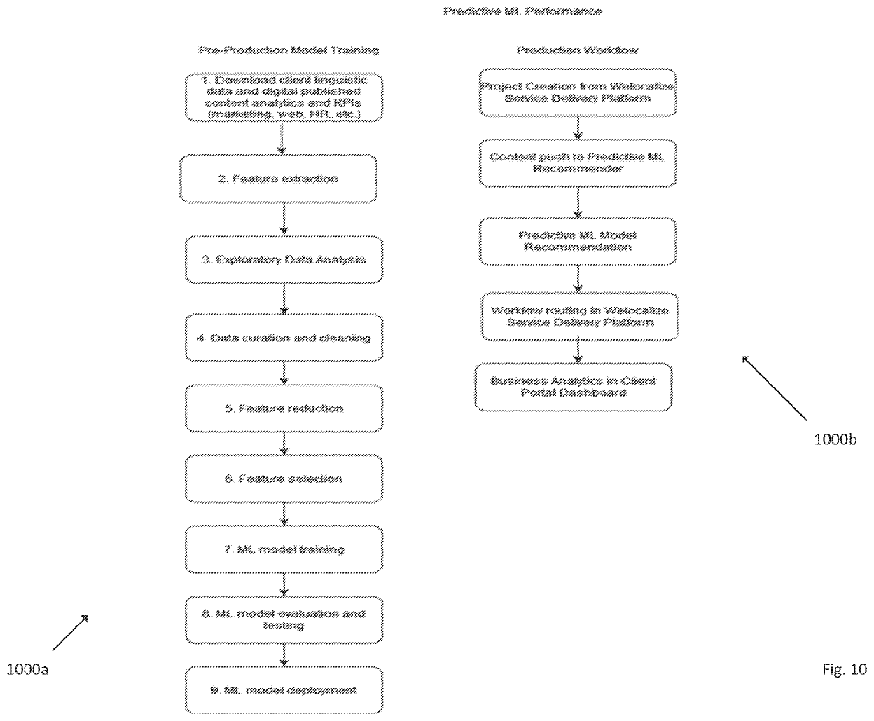

FIG. 10 shows a first flowchart of an embodiment of a process to train a model and a second flowchart of an embodiment of a process to deploy the model as trained according to this disclosure. In particular, there is a process 1000a to train a machine learning model and a process 1000b to deploy the model as trained, each as described and shown in context of FIGS. 7-9 for the application program 202 (or another suitable logic running on the computing instance 104). For example, the process 1000a can include a pre-production computing environment enabled by the application program 202 (or another suitable logic running on the computing instance 104) to select the machine learning model 708 from the set of machine learning models training on two datasets: (1) the set of unstructured texts and (2) the set of user engagement analytic parameters. Likewise, for example, the process 1000b can include an actual production computing environment enabled by the application program 202 (or another suitable logic running on the computing instance 104) where a project workspace is created, analysis process is triggered and a report is presented to the text source terminal 108 via a dashboard, as disclosed herein.

The process 1000a is used for model training and includes steps 1-9 performed by the application program 202 (or another suitable logic running on the computing instance 104) to enable various technologies described and shown in context of FIGS. 7-9 for the application program 202 (or another suitable logic running on the computing instance 104). Note that the application program 202 (or another suitable logic running on the computing instance 104) may be enabled for some user profiles to run scripts (e.g., Perl, Python) thereon, as further described below.

In step 1, the text source terminal 108 avails a content for linguistic analysis (e.g., the set of unstructured texts recited in the source language) and a set of digital published content analytics (e.g., the set of user engagement analytic parameters) to the application program 202 (or another suitable logic running on the computing instance 104). In this step, the content for analysis may be availed via a file sharing service (e.g., Sharefile, Dropbox) or otherwise (e.g., email, chat) external to the computing instance 104 and in communication with the network 102. For example, this may occur when the text source terminal 108 uploads the content for linguistic analysis in an electronic file format (e.g., a data file, a DOCX file, a XLSX file, a PPTX file, an HTML file, a TXT file) and the set of digital published content analytics in an electronic file format (e.g., a data file, a dat file, a CSV file, a XLSX file, a TSV file, a TXT file, a JSON file) to the file sharing service, which shares the content for linguistic analysis and the set of digital published content analytics with the application program 202 (or another suitable logic running on the computing instance 104). The file sharing service sends an email notification (or another type of notification) to the administrator user profile at the administrator terminal 106, who in response downloads the content for linguistic analysis and the set of digital published content analytics from the file sharing service onto the application program 202 (or another suitable logic running on the computing instance 104). The administrator user profile at the administrator terminal 106 interfaces with the application program 202 (or another suitable logic running on the computing instance 104) to assign various tasks of feature extraction, exploratory data analysis, data curation and subsequent model training to an engineer user profile operating an engineer terminal in communication with the application program 202 (or another suitable logic running on the computing instance 104) over the network 102, where such assignment may occur using a hosted software solution for project tracking (e.g., Atlassian Jira). The engineer user profile receives an email notification from the file sharing service or the hosted software solution for project tracking that a task has been assigned to the engineer user profile.

In step 2, various technologies described and shown in context of FIGS. 2-6 are run to extract a list of linguistic features and corresponding feature numbers for every sentence in the content for linguistic analysis. For example, this may occur via the engineer user profile accessing the application program 202 (or another suitable logic running on the computing instance 104) to navigate to the content for linguistic analysis and the set of digital published content analytics downloaded files in Step 1 and use a script (e.g., Python, Perl) running on the application program 202 (or another suitable logic running on the computing instance 104), which automatically opens each file in a text editor and provides a log of any corrupt or erroneous files that cannot be opened on the application program 202 (or another suitable logic running on the computing instance 104) to. If any of those file(s) is corrupt, then the engineer user profile notes such files in the hosted software solution for project tracking, which in turn sends a notification (e.g., an email) to the administrator user profile at the administrator terminal 106 who in turn sends a notice (e.g., an email) to the text source terminal 108 to obtain corresponding new electronic files if such files are available. However, if those file(s) are not corrupt, then engineer user profile converts all those file(s) to a text-based electronic format (e.g., a TXT format, a delimited format (e.g., CSV, TSV) using a script (e.g., Python, Perl) on the application program 202 (or another suitable logic running on the computing instance 104). Then, the engineer user profile runs a script running on the application program 202 (or another suitable logic running on the computing instance 104) to extract a list of linguistic features and corresponding feature numbers for every sentence (e.g., a number of nouns, a number adjectives, a number of pronouns, a number of words in a sentence) in the content for linguistic analysis on the application program 202 (or another suitable logic running on the computing instance 104) to. Then, the engineer user profile runs a script (e.g., Python, Perl) on the application program 202 (or another suitable logic running on the computing instance 104) to automatically verify that the set of digital published content analytics corresponds to the extracted linguistic features (e.g., every sentence or web page has relevant analytics such as time spent on web page, conversion rate, return on advertising spend, cost per click).

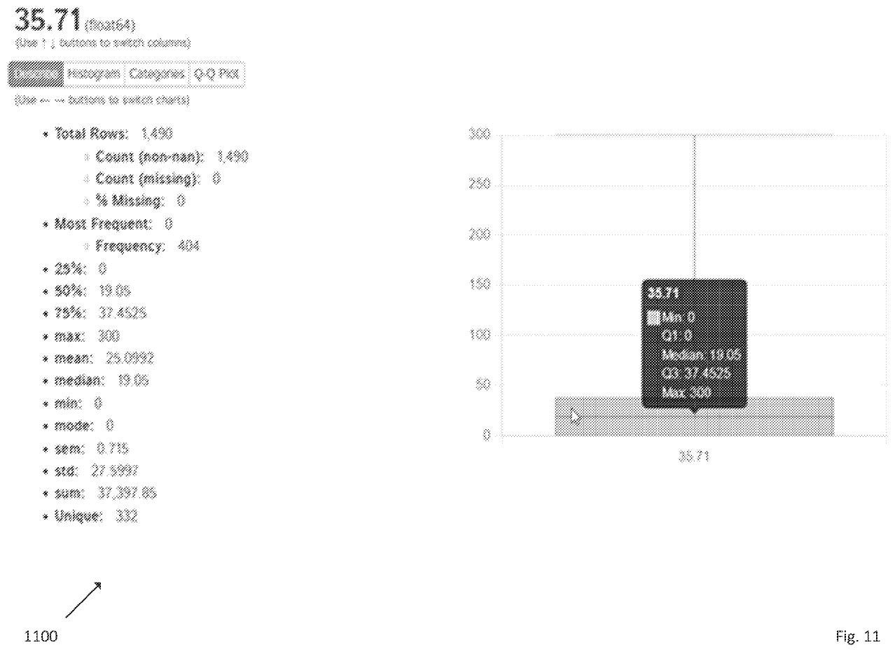

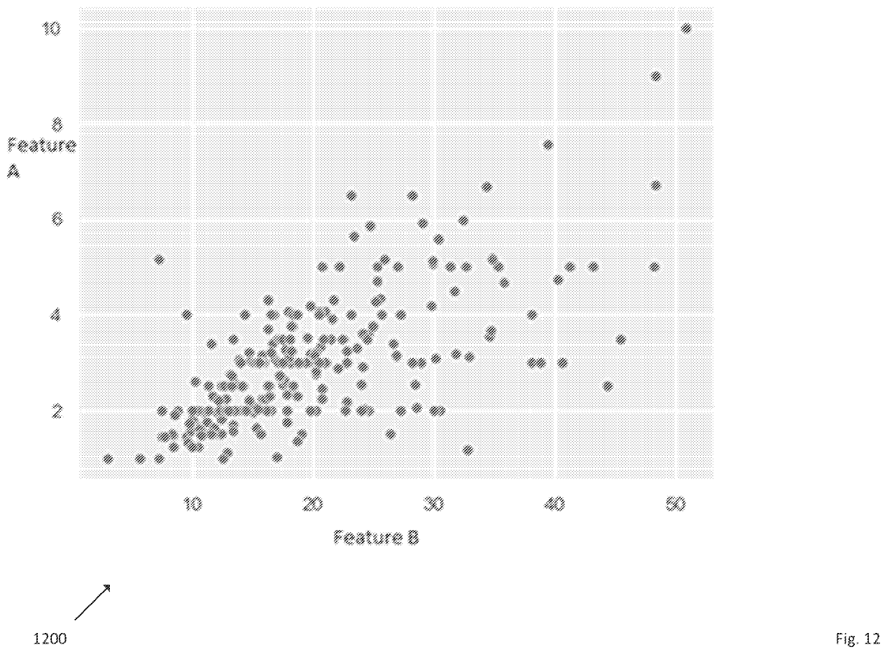

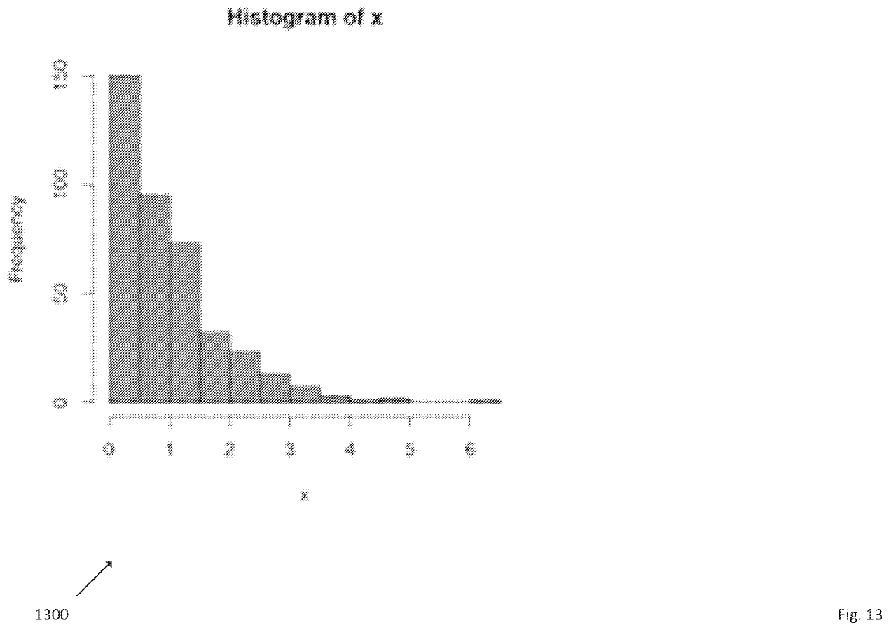

In step 3, the application program 202 (or another suitable logic running on the computing instance 104) performs exploratory data analysis and calibrates various thresholds described and illustrated in context of FIGS. 2-6 for the content for linguistic analysis and discover patterns, spot anomalies, check for noisy or unreliable data pertaining to the set of digital published content analytics. In this step, various scripts (e.g., Perl, Python) running on the application program 202 (or another suitable logic running on the computing instance 104) are used to analyze and describe this data, both the content for linguistic analysis and the set of digital published content analytics. For example, such processing enables understanding of how many rows and columns are present in this data, what is its count, unique count, mean, standard deviation, min, and max for numeric variables, and other statistical information. What rows have continuous variables and what rows have categorical (discrete variables) are noted and those rows that have null values and/or extreme outliers (2 standard deviations or more) in case such outliers are inaccurate and can be removed. For example, some Python commands that may be used include data.dtypes, shape, head, columns, nunique, describe, or other suitable commands. As such, the engineer user profile will run some scripts (e.g., Python, Perl) on the application program 202 (or another suitable logic running on the computing instance 104) to describe this data for each file and store those results in a separate data file (e.g., a delimited file, a CSV file). The scripts may include Python commands such as data.dtypes, shape, head, columns, nunique, describe, or other suitable commands. For example, .shape returns the number of rows by the number of columns in the dataset. For example, .nunique returns the number of unique values for each variable. For example, .describe summarizes the count, mean, standard deviation, min, and max for numeric variables. Note that this is shown in FIG. 11, where FIG. 11 shows a diagram 1100 of an embodiment of count, mean, standard deviation, min, and max for numeric variables used in the process to train the model of FIG. 10 according to this disclosure. For example, data.dtypes inform about: type of the data (integer, float, Python object, etc.) and size of the data (number of bytes). For example, sns.pairplot( ) function will be run to show the interaction between multiple variables using scatterlot or histogram per diagrams below. Note that this is shown in FIGS. 12 and 13, where FIG. 12 shows a diagram 1200 of an embodiment of a scatterplot between features A and B used in the process to train the model of FIG. 10 according to this disclosure, and where FIG. 13 shows a diagram 1300 of an embodiment of a histogram of correlations between X and frequency used in the process to train the model of FIG. 10 according to this disclosure.

In step 4, the application program 202 (or another suitable logic running on the computing instance 104) performs data curation and cleaning to remove noisy and unreliable data from the content for linguistic analysis and the set of digital published content analytics. In this step, various scripts (e.g., Python, Perl) running on the application program 202 (or another suitable logic running on the computing instance 104) are used to remove or convert null values, remove extreme outliers, and convert categorical variables to numerical values. For example, some Python commands can include drop, replace, fillna. For example, if the engineer user profile decides that some columns or rows of the aforementioned files are not relevant for model building, then DataFrame.drop command is used to remove such columns or rows. For example, if the engineer user profile decides that some columns or rows of the aforementioned files are relevant for model building, but not in the correct format, then DataFrame.replace command is used to convert categorical variables such as yes/no to numerical variables such as 1/0. For example, if the engineer user profile decides that some columns or rows of the aforementioned files are relevant for model building, but not in the correct format, then DataFrame.fillna command is used to convert null values into actual values if a correct value is known or can be ascertained or a value such as Null or Zero will be used.

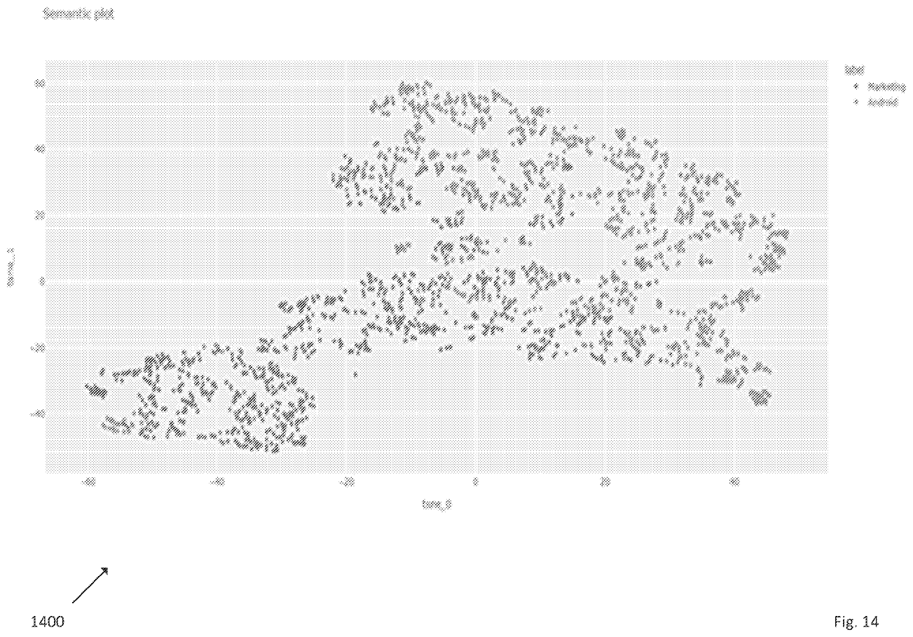

In step 5, the application program 202 (or another suitable logic running on the computing instance 104) performs feature reduction to transform features to a format amenable for training the machine learning model 708. In this step, various scripts (e.g., Python, Perl) run on the application program 202 (or another suitable logic running on the computing instance 104) are used to reduce a number of features to reduce model complexity, model overfitting, enhance model computation efficiency and reduce generalization error. Some techniques may include Principle Components Analysis (PCA), Independent Component Analysis (ICA), Linear Discriminant Analysis (LDA), Locally Linear Embedding (LLE), t-distributed Stochastic Neighbor Embedding (t-SNE), Autoencoders (AE), or other suitable techniques. Although this specific example uses t-SNE technique for reducing high dimensional data associated with sentence embeddings to a low dimensionality of 2D for ease of visualization of similarity/dissimilarity and subsequent feature weight assignment, this is not required. Some, many, most, or all of the techniques listed above may be used in a production environment depending on the content for linguistic analysis and the set of digital published content analytics. For example, a script (e.g., Python, Perl) may be run on the application program 202 (or another suitable logic running on the computing instance 104) to use (a) a transformer model, distiluse-base-multilingual-cased-v1, to obtain sentence embeddings, (b) a t-sne technique, n_tsne_components=2, to reduce data dimensionality to 2D (x and y axis) for visualization, or (c) an instruction to print the 2D sentence embeddings visualizations to an image file in .png format (or another suitable format) shown in FIG. 14, where FIG. 14 shows a diagram 1400 of an embodiment of a visualization of sentence embeddings reduced to two dimensions to ascertain semantic similarity and dissimilarity used in the process to train the model of FIG. 10 according to this disclosure.

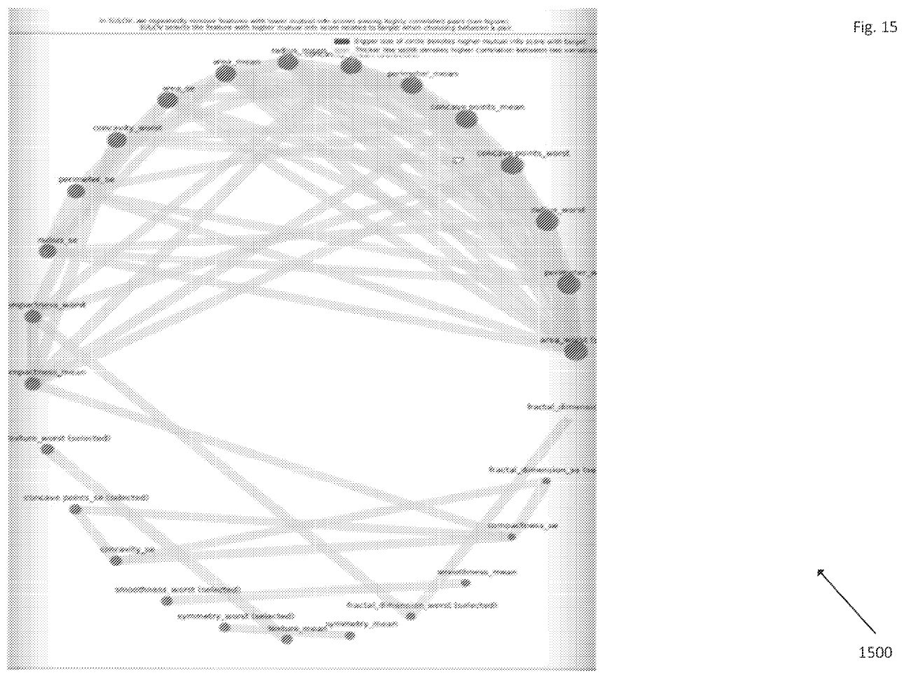

In step 6, the application program 202 (or another suitable logic running on the computing instance 104) performs feature selection by identifying importance of each feature in machine learning algorithms and removing (or ignoring) unnecessary features. In this step, various scripts (e.g., Python, Perl) running on the application program 202 (or another suitable logic running on the computing instance 104) are used to reduce a number of features to reduce model complexity, model overfitting, enhance model computation efficiency and reduce generalization error. Some techniques may include Wrapper methods (e.g., forward, backward, and stepwise selection), Filter methods (e.g., ANOVA, Pearson correlation, variance thresholding, Minimum-Redundancy-Maximum-Relevance (MRMR)), Embedded methods (e.g., Lasso, Ridge, Decision Tree), or other suitable techniques. Although his specific example uses MRMR technique, this is not required. Some, many, most, or all of the techniques listed above may be used in a production environment depending on the content for linguistic analysis and the set of digital published content analytics in step 3 above. For example, the engineer user profile may run a script (e.g., Python, Perl) with a library (e.g., a FeatureWiz library) on the application program 202 (or another suitable logic running on the computing instance 104) to find (a) all the pairs of highly correlated variables exceeding a correlation threshold such as 0.75 or (b) a mutual information score (MIS) of each feature to a target variable. The target variable (what we are trying accurately predict) comes from the set of digital published content analytics (e.g., a time period spent on a web page). The MIS is a non-parametric scoring method and is suitable for all kinds of variables and target in context of the content for linguistic analysis and the set of digital published content analytics. For example, the engineer user profile may run a script (e.g., Python, Perl) on the application program 202 (or another suitable logic running on the computing instance 104) to all eliminate features with a low MIS score as shown in FIG. 15, where FIG. 15 shows a diagram 1500 of an embodiment of a visualization of features and target variables where each visualized bubble has an area/circumference to visually indicate a mutual information score (larger is higher) and each visualized line has a thickness to visually indicate correlations (thicker is higher) used in the process to train the model of FIG. 10 according to this disclosure. The remaining, loosely correlated features are more salient and relevant are therefore used in step 7, model training.

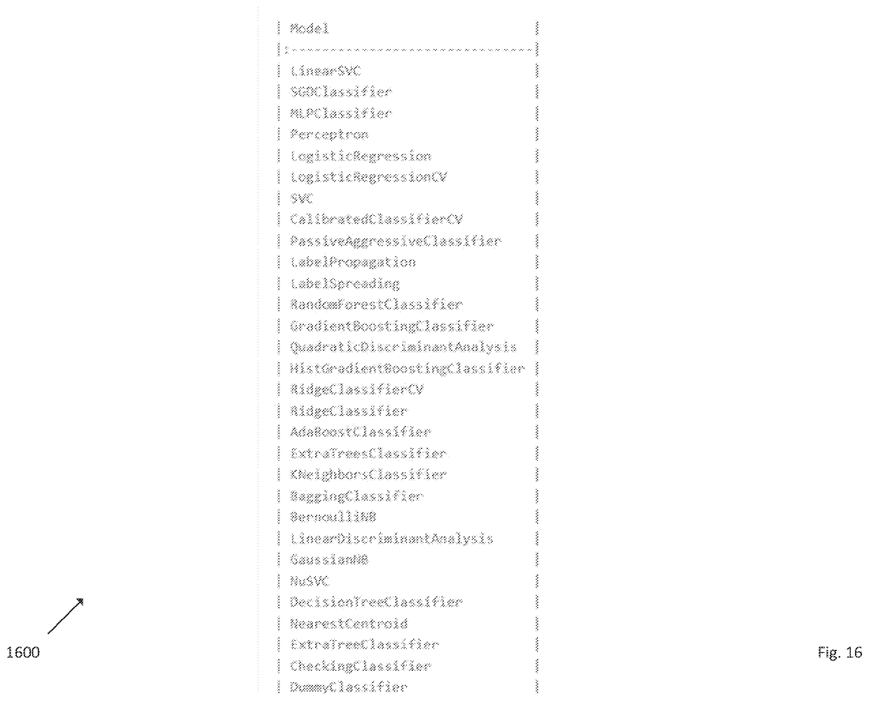

In step 7, the application program 202 (or another suitable logic running on the computing instance 104) performs model training by training using different machine learning algorithms. Such algorithms may include Linear Regression, Logistic Regression, Decision Tree, SVM, Naive Bayes, kNN, K-Means, Random Forest, XGBoost, LightGBM, CatBoost, or other suitable algorithms. Although this specific example uses Python Lazy predict library, this is not required. Some, many, most, or all of the techniques listed above may be used in a production environment depending on the content for linguistic analysis and the set of digital published content analytics in step 3 above. For example, the engineer user profile may run a script (e.g., Python, Perl) with LazyPredict classifier on the application program 202 (or another suitable logic running on the computing instance 104) to split a data set (the content for linguistic analysis and the set of digital published content analytics) into train and test sets, creates models for over 25 different classifiers shown in FIG. 16, where FIG. 16 shows a diagram 1600 of an embodiment of a listing of a set of algorithmic identifiers used in the process to train the model of FIG. 10 according to this disclosure, although less or more classifiers is possible.

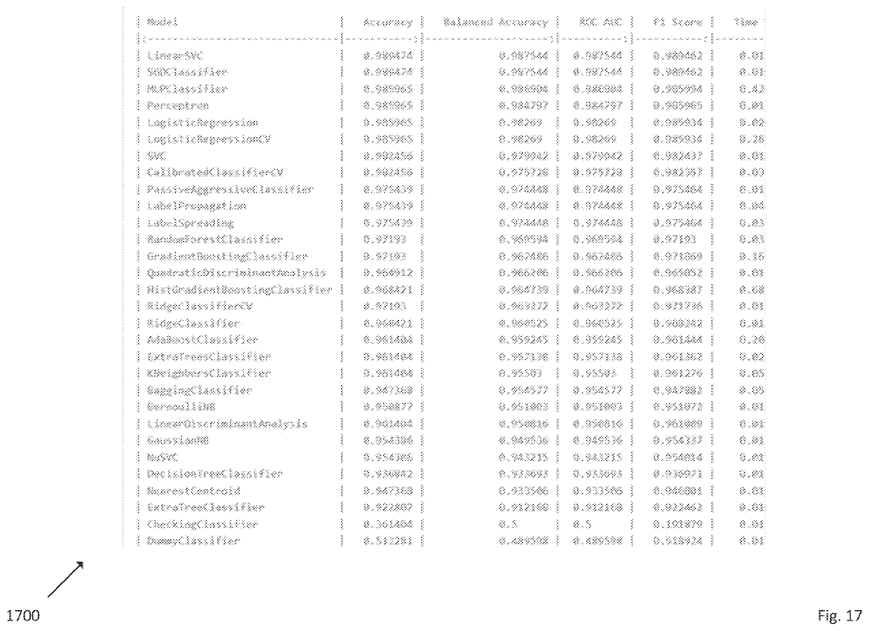

In step 8, the application program 202 (or another suitable logic running on the computing instance 104) performs model evaluation and testing by evaluating different machine learning algorithms for most accurate machine learning model to select, as explained above in context of FIGS. 7-9. In this step, the machine learning models are evaluated using techniques, such as confusion matrix, precision, recall, accuracy, receiver operating characteristic (ROC) curve, precision recall (PR) curve, or other suitable techniques. For example, the engineer user profile may run a script (e.g., Python, Perl) with a LazyPredict classifier on the application program 202 (or another suitable logic running on the computing instance 104) which may provide the accuracy, area under curve (AUC), ROC curve and F1 scores for each of the 25 (or more or less) different classifiers shown in FIG. 17, where FIG. 17 shows a diagram 1700 of an embodiment of a table listing a set of performance metrics to select a trained machine learning model to evaluate linguistic content to predict impact on a set of user engagement analytic parameters to route an unstructured text between an editing user interface and a translation user interface according to this disclosure. For example, the engineer user profile may provide these scores and a corresponding recommendation to the administrator user profile who may produce a statistical report for the text source terminal 108 in a requested format (e.g., PDF) to be communicated to the text source terminal 108 over the network 102 (e.g., email, messaging). Additionally or alternatively, the application program 202 (or another suitable logic running on the computing instance 104) may be programmed to read these scores, generate the corresponding recommendation according to a set of rules or heuristics based on reading these scores, and send the corresponding recommendation the text source terminal 108 over the network 102. For example, the engineer user profile may run a script on the application program 202 (or another suitable logic running on the computing instance 104) to import a pickle library (or another suitable library) and create a pickle file (or another suitable file) of a highest scoring classifier as mentioned above. For example, the pickle format may be a binary format (e.g., a binary file) and can be used as a process of converting a Python object into a byte stream for storage in a file/database, maintain program state across sessions, or transport data over the network 102 or within the application program 202 (or another suitable logic running on the computing instance 104). For example, the binary file 706 may be used.

In step 9, the application program 202 (or another suitable logic running on the computing instance 104) performs model deployment by deploying the machine learning model 708 that was selected from the set of machine learning models into the production environment. In this step, the machine learning model 708 is deployed to make predictions in the production environment when called via an application programming interface (API). For example, the engineer user profile may use a mlflow.sklearn library and load_model functions on the application program 202 (or another suitable logic running on the computing instance 104) to upload the binary 706 file such that the machine learning model 708 can provide predictions via various API requests from the application program 202 (or another suitable logic running on the computing instance 104).

The process 1000b is used for model application and includes steps 1-5 performed by the application program 202 (or another suitable logic running on the computing instance 104) to enable various technologies described and shown in context of FIGS. 7-9 for the application program 202 (or another suitable logic running on the computing instance 104).

In step 1, the application program 202 (or another suitable logic running on the computing instance 104) creates a dedicated workspace for the unstructured text with the set of linguistic features 702, as described above.

In step 2, the application program 202 (or another suitable logic running on the computing instance 104) accesses the unstructured text with the set of linguistic features 702 such that the machine learning model 708 in the binary file 706 grades the unstructured text with the set of linguistic features 702, as described above.

In step 3, the application program 202 (or another suitable logic running on the computing instance 104) generates the grade for the unstructured text with the set of linguistic features 702 via the machine learning model 708. For example, the application program 202 (or another suitable logic running on the computing instance 104 may generate a prediction on a scale from 1-10 using the machine learning model 708, where (a) 1-5 corresponds to a FAIL status and the unstructured text with the set of linguistic features 702 should be rewritten prior to translation, which may or may not occur via various technologies described and shown in context of FIGS. 2-6, or happen as otherwise disclosed herein, (b) 6-7 corresponds a REVIEW status and the unstructured text with the set of linguistic features 702 may/may not be rewritten prior to translation, which may or may not occur via various technologies described and shown in context of FIGS. 2-6, or happen as otherwise disclosed herein, or (c) 8-10 corresponds to a PASS status and the unstructured text with the set of linguistic features 702 can be routed to translation as is with no further editing, which may or may not occur via various technologies described and shown in context of FIGS. 2-6, or happen as otherwise disclosed herein.

In step 4, the application program 202 (or another suitable logic running on the computing instance 104) routes the unstructured text with the set of linguistic features 702 based on the score. As such, using the example above, the FAIL status may correspond to a sub-workflow 1 not to create a translation request and a technical writer is assigned to rewrite the unstructured text with the set of linguistic features 702 via the editor user profile at the editor terminal 112, which may loop as described above. Likewise, the PASS status may correspond to a sub-workflow 2 where the unstructured text with the set of linguistic features 702 is routed to translation step 1 and assigned to a linguist for that language combination based on the first language setting (e.g., English identifier) and the second language setting (e.g., Russian identifier) of the translator user profile at the translator terminal 110, as disclosed herein, to translate from the source language corresponding to the first language setting to the target language corresponding to the second language setting.

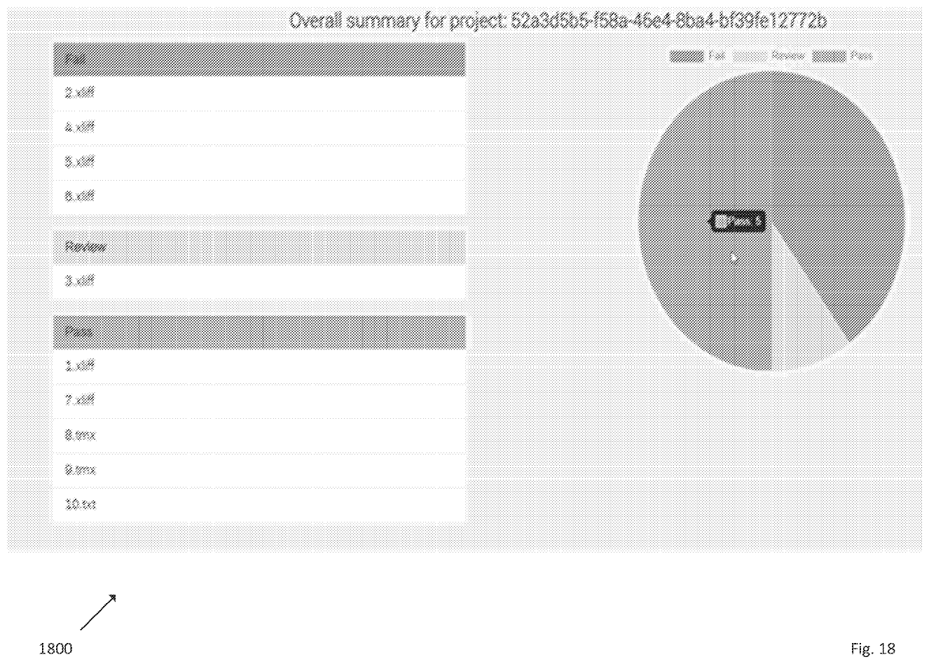

In step 5, the application program 202 (or another suitable logic running on the computing instance 104) enables a reporting user interface to the text source terminal 108 over the network 102. For example, the reporting user interface enables various business analytics (e.g., a number of unstructured text files that pass versus fail a user engagement analytic parameter threshold, a score for each analyzed file) that may be presented in a dashboard or can be exported as a data file (e.g., a DOCX file, a TXT file) or in a delimited format (e.g., CSV, TSV) for the text source terminal 108 to import into their own business analytics tool (e.g., Power BI, Tableau). For example, FIG. 18 shows a screenshot 1800 of an embodiment of a dashboard with a color-coded pie-diagram and a set of color-coded file groupings generated based on the trained machine learning model selected in FIG. 17 according to this disclosure. As shown in FIG. 18, the computing instance 104 may be programmed to present a dashboard containing a statistical report based on the unstructured text with the set of linguistic features 702 and another unstructured text not included in the set of unstructured texts. The statistical report may be associated with the data source (e.g., custom to that data source or the text source terminal 106) relative to the decision threshold being satisfied and not satisfied for the unstructured text and the another unstructured text(s). As such, a viewer operating the data source or the text source terminal 106 may understand how many unstructured texts passed or failed or unclear when the grade allows for such tiers. For example, the statistical report may outline an impact of certain linguistic features on certain user engagement analytic parameters and have (or link to) certain specific recommendations for editing the unstructured text with the set of linguistic features 702 to influence (e.g., increase, decrease) the impact of certain linguistic features on certain user engagement analytic parameters.

Various embodiments of the present disclosure may be implemented in a data processing system suitable for storing and/or executing program code that includes at least one processor coupled directly or indirectly to memory elements through a system bus. The memory elements include, for instance, local memory employed during actual execution of the program code, bulk storage, and cache memory which provide temporary storage of at least some program code in order to reduce the number of times code must be retrieved from bulk storage during execution.

I/O devices (including, but not limited to, keyboards, displays, pointing devices, DASD, tape, CDs, DVDs, thumb drives and other memory media, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the available types of network adapters.

This disclosure may be embodied in a system, a method, and/or a computer program product. The computer program product may include a computer readable storage medium (or media) having computer readable program instructions thereon for causing a processor to carry out aspects of the present disclosure. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, among others. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In various embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions. The various illustrative logical blocks, modules, circuits, and algorithm steps described in connection with the embodiments disclosed herein may be implemented as electronic hardware, computer soft-ware, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

Although various embodiments have been depicted and described in detail herein, skilled artisans know that various modifications, additions, substitutions and the like can be made without departing from this disclosure. As such, these modifications, additions, substitutions and the like are considered to be within this disclosure.

1. A system comprising:
a computing instance including an editor profile accessed from an editor terminal, a translator profile accessed from a translator terminal, and a logic including a binary file containing a machine learning model selected based on a set of performance metrics from a set of machine learning models trained by a set of supervised machine learning algorithms on (i) a set of unstructured texts recited in a source language and containing a set of linguistic features and (ii) a set of user engagement analytic parameters measured for the set of unstructured texts to correlate how the set of linguistic features identified in the set of unstructured texts is predicted to impact the set of user engagement analytic parameters, wherein the editor profile includes an editor language setting, wherein the translator profile includes a first translator language setting and a second translator language setting, wherein the computing instance is programmed to:
receive (i) an unstructured text recited in the source language and containing the set of linguistic features and (ii) an identifier of a target language from a data source external to the computing instance, wherein the unstructured text is not present in the set of unstructured texts;
input the unstructured text into the logic such that the logic reads the binary file and generates a grade for the unstructured text via the machine learning model, wherein the grade correlates how the set of linguistic features identified in the unstructured text is predicted to impact the set of user engagement analytic parameters for the unstructured text;
determine whether the grade satisfies a decision threshold associated with how the set of linguistic features identified in the unstructured text is predicted to impact the set of user engagement analytic parameters;
route the unstructured text within the computing instance based on the grade not satisfying the decision threshold such that the unstructured text is (i) assigned to the editor profile based on the editor language setting corresponding to the source language detected in the unstructured text and (ii) edited via the editor profile from the editor terminal to satisfy the decision threshold based on a corrective content (i) generated by the logic when the logic generated the grade for the unstructured text via the machine learning model and (ii) presented to the editor profile to be visualized at the editor terminal such that the unstructured text as edited via the editor profile from the editor terminal based on the corrective content is again input into the logic for the logic to read the binary file, generate the grade for the unstructured text as edited via the editor profile from the editor terminal based on the corrective content via the machine learning model, and satisfy the decision threshold; and
route the unstructured text within the computing instance based on the grade satisfying the decision threshold such that the unstructured text is (i) assigned to the translator profile based on the first translator language setting corresponding to the source language detected in the unstructured text and the second translator language setting corresponding to the identifier, (ii) translated via the translator profile from the translator terminal into the target language via the computing instance, and (iii) sent to the data source to be end-used.

2. The system of claim 1, wherein the set of user engagement analytic parameters includes at least a user satisfaction parameter, a click-through rate parameter, a view rate parameter, a conversion rate parameter, or a time period spent on a web page parameter, wherein the grade correlates how the set of linguistic features identified in the unstructured text is predicted to impact at least the user satisfaction parameter, a click-through rate parameter, a view rate parameter, a conversion rate parameter, or a time period spent on a web page parameter, wherein the corrective content is generated by the logic based on improving at least the user satisfaction parameter, a click-through rate parameter, a view rate parameter, a conversion rate parameter, or a time period spent on a web page parameter.

3-6. (canceled)

7. The system of claim 1, wherein the corrective content is generated by the logic at least based on a number of nouns per sentence, a set of sentences, a set of consecutive sentences, or the unstructured text as a whole identified in the unstructured text such that the unstructured text as edited via the editor profile from the editor terminal based on the corrective content to impact at least the number of nouns per sentence, a set of sentences, a set of consecutive sentences, or the unstructured text as a whole is again input into the logic for the logic to read the binary file, generate the grade for the unstructured text as edited via the editor profile from the editor terminal based on the corrective content to impact at least the number of nouns per sentence, a set of sentences, a set of consecutive sentences, or the unstructured text as a whole via the machine learning model, and satisfy the decision threshold based on impacting at least the number of nouns per sentence, a set of sentences, a set of consecutive sentences, or the unstructured text as a whole.

8. The system of claim 1, wherein the corrective content is generated by the logic at least based on a score of a readability formula applied to the unstructured text such that the unstructured text as edited via the editor profile from the editor terminal based on the corrective content to impact at least the score of the readability formula is again input into the logic for the logic to read the binary file, generate the grade for the unstructured text as edited via the editor profile from the editor terminal based on the corrective content to impact at least the score of the readability formula via the machine learning model, and satisfy the decision threshold based on impacting at least the score of the readability formula.

9. The system of claim 1, wherein the corrective content is generated by the logic at least based on a nominalization frequency per sentence, a set of sentences, a set of consecutive sentences, or the unstructured text as a whole measured for the unstructured text such that the unstructured text as edited via the editor profile from the editor terminal based on the corrective content to impact at least the nominalization frequency is again input into the logic for the logic to read the binary file, generate the grade for the unstructured text as edited via the editor profile from the editor terminal based on the corrective content to impact at least the nominalization frequency via the machine learning model, and satisfy the decision threshold based on impacting at least the nominalization frequency.

10. The system of claim 1, wherein the corrective content is generated by the logic at least based on a number of words exceeding a predetermined length per sentence, a set of sentences, a set of consecutive sentences, or the unstructured text as a whole identified in the unstructured text such that the unstructured text as edited via the editor profile from the editor terminal based on the corrective content to impact at least the number of words exceeding the predetermined length is again input into the logic for the logic to read the binary file, generate the grade for the unstructured text as edited via the editor profile from the editor terminal based on the corrective content to impact at least the number of words exceeding the predetermined length via the machine learning model, and satisfy the decision threshold based on impacting at least the number of words exceeding the predetermined length.

11. The system of claim 1, wherein the corrective content is generated by the logic at least based on a word count per sentence, a set of sentences, a set of consecutive sentences, or the unstructured text as a whole counted in the unstructured text such that the unstructured text as edited via the editor profile from the editor terminal based on the corrective content to impact at least the word count is again input into the logic for the logic to read the binary file, generate the grade for the unstructured text as edited via the editor profile from the editor terminal based on the corrective content to impact at least the word count via the machine learning model, and satisfy the decision threshold based on impacting at least the word count.

12. The system of claim 1, wherein the corrective content is generated by the logic at least based on an abbreviation definition identified in the unstructured text such that the unstructured text as edited via the editor profile from the editor terminal based on the corrective content to impact at least the abbreviation definition is again input into the logic for the logic to read the binary file, generate the grade for the unstructured text as edited via the editor profile from the editor terminal based on the corrective content to impact at least the abbreviation definition via the machine learning model, and satisfy the decision threshold based on impacting at least the abbreviation definition.

13. The system of claim 1, wherein the corrective content is generated by the logic at least based on a number of adjectives, adpositions, numerals, particles, adverbs, pronouns, auxiliaries, or proper nouns per sentence, a set of sentences, a set of consecutive sentences, or the unstructured text as a whole identified in the unstructured text such that the unstructured text as edited via the editor profile from the editor terminal based on the corrective content to impact at least the number of adjectives, adpositions, numerals, particles, adverbs, pronouns, auxiliaries, or proper nouns per sentence, a set of sentences, a set of consecutive sentences, or the unstructured text as a whole is again input into the logic for the logic to read the binary file, generate the grade for the unstructured text as edited via the editor profile from the editor terminal based on the corrective content to impact at least the number of adjectives, adpositions, numerals, particles, adverbs, pronouns, auxiliaries, or proper nouns per sentence, a set of sentences, a set of consecutive sentences, or the unstructured text as a whole via the machine learning model, and satisfy the decision threshold based on impacting at least the number of adjectives, adpositions, numerals, particles, adverbs, pronouns, auxiliaries, or proper nouns per sentence, a set of sentences, a set of consecutive sentences, or the unstructured text as a whole.

14-20. (canceled)

21. The system of claim 1, wherein the corrective content is generated by the logic at least based on a number of coordinating conjunctions per sentence, a set of sentences, a set of consecutive sentences, or the unstructured text as a whole identified in the unstructured text such that the unstructured text as edited via the editor profile from the editor terminal based on the corrective content to impact at least the number of coordinating conjunctions per sentence, a set of sentences, a set of consecutive sentences, or the unstructured text as a whole is again input into the logic for the logic to read the binary file, generate the grade for the unstructured text as edited via the editor profile from the editor terminal based on the corrective content to impact at least the number of coordinating conjunctions per sentence, a set of sentences, a set of consecutive sentences, or the unstructured text as a whole via the machine learning model, and satisfy the decision threshold based on impacting at least the number of coordinating conjunctions per sentence, a set of sentences, a set of consecutive sentences, or the unstructured text as a whole.

22. The system of claim 1, wherein the corrective content is generated by the logic at least based on a number of punctuations per sentence, a set of sentences, a set of consecutive sentences, or the unstructured text as a whole identified in the unstructured text such that the unstructured text as edited via the editor profile from the editor terminal based on the corrective content to impact at least the number of punctuations per sentence, a set of sentences, a set of consecutive sentences, or the unstructured text as a whole is again input into the logic for the logic to read the binary file, generate the grade for the unstructured text as edited via the editor profile from the editor terminal based on the corrective content to impact at least the number of punctuations per sentence, a set of sentences, a set of consecutive sentences, or the unstructured text as a whole via the machine learning model, and satisfy the decision threshold based on impacting at least the number of punctuations per sentence, a set of sentences, a set of consecutive sentences, or the unstructured text as a whole.

23. The system of claim 1, wherein the corrective content is generated by the logic at least based on a number of determiners per sentence, a set of sentences, a set of consecutive sentences, or the unstructured text as a whole identified in the unstructured text such that the unstructured text as edited via the editor profile from the editor terminal based on the corrective content to impact at least the number of determiners per sentence, a set of sentences, a set of consecutive sentences, or the unstructured text as a whole is again input into the logic for the logic to read the binary file, generate the grade for the unstructured text as edited via the editor profile from the editor terminal based on the corrective content to impact at least the number of determiners per sentence, a set of sentences, a set of consecutive sentences, or the unstructured text as a whole via the machine learning model, and satisfy the decision threshold based on impacting at least the number of determiners per sentence, a set of sentences, a set of consecutive sentences, or the unstructured text as a whole.

24. The system of claim 1, wherein the corrective content is generated by the logic at least based on a number of subordinating conjunctions per sentence, a set of sentences, a set of consecutive sentences, or the unstructured text as a whole identified in the unstructured text such that the unstructured text as edited via the editor profile from the editor terminal based on the corrective content to impact at least the number of subordinating conjunctions per sentence, a set of sentences, a set of consecutive sentences, or the unstructured text as a whole is again input into the logic for the logic to read the binary file, generate the grade for the unstructured text as edited via the editor profile from the editor terminal based on the corrective content to impact at least the number of subordinating conjunctions per sentence, a set of sentences, a set of consecutive sentences, or the unstructured text as a whole via the machine learning model, and satisfy the decision threshold based on impacting at least the number of subordinating conjunctions per sentence, a set of sentences, a set of consecutive sentences, or the unstructured text as a whole.

25. The system of claim 1, wherein the corrective content is generated by the logic at least based on a number of interjections per sentence, a set of sentences, a set of consecutive sentences, or the unstructured text as a whole identified in the unstructured text such that the unstructured text as edited via the editor profile from the editor terminal based on the corrective content to impact at least the number of interjections per sentence, a set of sentences, a set of consecutive sentences, or the unstructured text as a whole is again input into the logic for the logic to read the binary file, generate the grade for the unstructured text as edited via the editor profile from the editor terminal based on the corrective content to impact at least the number of interjections per sentence, a set of sentences, a set of consecutive sentences, or the unstructured text as a whole via the machine learning model, and satisfy the decision threshold based on impacting at least the number of interjections per sentence, a set of sentences, a set of consecutive sentences, or the unstructured text as a whole.

26. The system of claim 1, wherein the corrective content is generated by the logic at least based on a number of symbols per sentence, a set of sentences, a set of consecutive sentences, or the unstructured text as a whole identified in the unstructured text such that the unstructured text as edited via the editor profile from the editor terminal based on the corrective content to impact at least the number of symbols per sentence, a set of sentences, a set of consecutive sentences, or the unstructured text as a whole is again input into the logic for the logic to read the binary file, generate the grade for the unstructured text as edited via the editor profile from the editor terminal based on the corrective content to impact at least the number of symbols per sentence, a set of sentences, a set of consecutive sentences, or the unstructured text as a whole via the machine learning model, and satisfy the decision threshold based on impacting at least the number of symbols per sentence, a set of sentences, a set of consecutive sentences, or the unstructured text as a whole.

27. The system of claim 1, wherein the corrective content is generated by the logic at least based on a number of verbs per sentence, a set of sentences, a set of consecutive sentences, or the unstructured text as a whole identified in the unstructured text such that the unstructured text as edited via the editor profile from the editor terminal based on the corrective content to impact at least the number of verbs per sentence, a set of sentences, a set of consecutive sentences, or the unstructured text as a whole is again input into the logic for the logic to read the binary file, generate the grade for the unstructured text as edited via the editor profile from the editor terminal based on the corrective content to impact at least the number of verbs per sentence, a set of sentences, a set of consecutive sentences, or the unstructured text as a whole via the machine learning model, and satisfy the decision threshold based on impacting at least the number of verbs per sentence, a set of sentences, a set of consecutive sentences, or the unstructured text as a whole.

28. The system of claim 1, wherein the corrective content is generated by the logic at least based on a language model score generated for the unstructured text such that the unstructured text as edited via the editor profile from the editor terminal based on the corrective content to impact at least the language model score is again input into the logic for the logic to read the binary file, generate the grade for the unstructured text as edited via the editor profile from the editor terminal based on the corrective content to impact at least the language model score via the machine learning model, and satisfy the decision threshold based on impacting at least the language model score.

29. The system of claim 1, wherein the corrective content is generated by the logic at least based on an adjective-noun density per sentence, a set of sentences, a set of consecutive sentences, or the unstructured text as a whole identified in the unstructured text such that the unstructured text as edited via the editor profile from the editor terminal based on the corrective content to impact at least the adjective-noun density per sentence, a set of sentences, a set of consecutive sentences, or the unstructured text as a whole is again input into the logic for the logic to read the binary file, generate the grade for the unstructured text as edited via the editor profile from the editor terminal based on the corrective content to impact at least the adjective-noun density per sentence, a set of sentences, a set of consecutive sentences, or the unstructured text as a whole via the machine learning model, and satisfy the decision threshold based on impacting at least the adjective-noun density per sentence, a set of sentences, a set of consecutive sentences, or the unstructured text as a whole.

30. The system of claim 1, wherein the corrective content is generated by the logic at least based on a number of syllables, unique words, complex words, long words, words, or nominalizations per sentence, a set of sentences, a set of consecutive sentences, or the unstructured text as a whole identified in the unstructured text such that the unstructured text as edited via the editor profile from the editor terminal based on the corrective content to impact at least the number of syllables, unique words, complex words, long words, words, or nominalizations per sentence, a set of sentences, a set of consecutive sentences, or the unstructured text as a whole is again input into the logic for the logic to read the binary file, generate the grade for the unstructured text as edited via the editor profile from the editor terminal based on the corrective content to impact at least the number of syllables, unique words, complex words, long words, words, or nominalizations per sentence, a set of sentences, a set of consecutive sentences, or the unstructured text as a whole via the machine learning model, and satisfy the decision threshold based on impacting at least the number of syllables, unique words, complex words, long words, words, or nominalizations per sentence, a set of sentences, a set of consecutive sentences, or the unstructured text as a whole.

31-33. (canceled)

34. The system of claim 1, wherein the corrective content is generated by the logic at least based on a maximum or mean similarity scoring per sentence, a set of sentences, a set of consecutive sentences, or the unstructured text as a whole generated on the unstructured text such that the unstructured text as edited via the editor profile from the editor terminal based on the corrective content to impact at least the maximum or mean similarity scoring per sentence, a set of sentences, a set of consecutive sentences, or the unstructured text as a whole is again input into the logic for the logic to read the binary file, generate the grade for the unstructured text as edited via the editor profile from the editor terminal based on the corrective content to impact at least the maximum or mean similarity scoring per sentence, a set of sentences, a set of consecutive sentences, or the unstructured text as a whole via the machine learning model, and satisfy the decision threshold based on impacting at least the maximum or mean similarity scoring per sentence, a set of sentences, a set of consecutive sentences, or the unstructured text as a whole.

35-44. (canceled)

45. The system of claim 1, wherein the grade correlates how the set of linguistic features identified in the unstructured text is predicted to impact the set of user engagement analytic parameters based on sentence embedding to measure stylistic similarity or dissimilarity to the set of unstructured texts.

46-48. (canceled)

49. The system of claim 1, wherein the set of linguistic features includes a linguistic feature invoking a part of speech rule for the source language, a complexity formula for the source language, a readability formula for the source language, or a measure of similarity to a historical source unstructured text for the source language, wherein the grade correlates how at least the linguistic feature identified in the unstructured text is predicted to impact the set of user engagement analytic parameters, wherein the corrective content is generated by the logic at least based on the linguistic feature.

50-82. (canceled)
